(19) United States
(12) Patent Application Publication
(10) Pub. No.: US 2026/0239386 A1
(43) Pub. Date: Aug. 13, 2026

(54) PSFCH TRANSMISSION METHOD AND APPARATUS

(71) Applicant: Beijing Xiaomi Mobile Software Co., Ltd., Beijing (CN)

(72) Inventors: Qun ZHAO, Beijing (CN); Mingju LI, Beijing (CN)

(73) Assignee: Beijing Xiaomi Mobile Software Co., Ltd., Beijing (CN)

(21) Appl. No.: 19/156,228

(22) PCT Filed: Feb. 15, 2023
(86) PCT No.: PCT/CN2023/076299

§ 371 Date: Aug. 13, 2025

(51) Int. Cl. H04W 72/25

(52) U.S. Cl. CPC H04W 72/25

(57) ABSTRACT

A method for transmitting a Physical Sidelink Feedback Channel (PSFCH), performed by a terminal, including: determining N1 PSFCHs from N PSFCHs and at least one transmission beam, where the N PSFCHs are PSFCHs to be simultaneously transmitted by the terminal, both N and N1 are positive integers, N1 is less than or equal to N, N is greater than or equal to 2, and the at least one transmission beam is configured to transmit the N1 PSFCHs.

### CROSS REFERENCE TO RELATED APPLICATION

The present application is a U.S. National Stage of International Application No. PCT/CN2023/076299, filed on Feb. 15, 2023, the entire contents of which are incorporated herein by reference.

### BACKGROUND OF THE INVENTION

With the development of science and technology, it has become possible to perform sidelink communication using higher millimeter-wave frequency bands in a communication system. For example, a sending terminal and a receiving terminal may use millimeter-wave frequency bands in a manner of analog beamforming or analog-digital hybrid beamforming. In order to improve the quality of the communication between the sending terminal and the receiving terminal, a transmission beam and a reception beam may be paired to form a beam pair with better communication quality.

### SUMMARY OF THE INVENTION

An embodiment of a first aspect of the present disclosure proposes a method for transmitting a Physical Sidelink Feedback Channel (PSFCH). The method is performed by a terminal and includes:
determining N1 PSFCHs from N PSFCHs and at least one transmission beam, where the N PSFCHs are PSFCHs to be simultaneously transmitted by the terminal, both N and N1 are positive integers, N1 is less than or equal to N, N is greater than or equal to 2, and the at least one transmission beam is configured to transmit the N1 PSFCHs.

An embodiment of a second aspect of the present disclosure proposes a terminal including a processor and a memory. The memory stores a computer program, and the processor executes the computer program stored in the memory to enable the terminal to perform:
determining N1 PSFCHs from N PSFCHs and at least one transmission beam, where the N PSFCHs are PSFCHs to be simultaneously transmitted by the terminal, both N and N1 are positive integers, N1 is less than or equal to N, N is greater than or equal to 2, and the at least one transmission beam is configured to transmit the N1 PSFCHs.

An embodiment of a third aspect of the present disclosure proposes a non-transitory computer-readable storage medium configured to store instructions. The instructions, when executed, cause the following step to be implemented:
determining N1 PSFCHs from N PSFCHs and at least one transmission beam, where the N PSFCHs are PSFCHs to be simultaneously transmitted by the terminal, both N and N1 are positive integers, N1 is less than or equal to N, N is greater than or equal to 2, and the at least one transmission beam is configured to transmit the N1 PSFCHs.

### BRIEF DESCRIPTION OF DRAWINGS

The above and/or additional aspects and benefits of the present disclosure will become apparent and easily understood from the following description of embodiments with reference to the accompanying drawings.

FIG. 1 is a schematic diagram of an architecture of a communication system provided by one embodiment of the present disclosure.

FIG. 2 is a schematic flowchart of a method for transmitting a PSFCH provided by one embodiment of the present disclosure.

FIG. 3 is a schematic flowchart of a method for transmitting a PSFCH provided by another embodiment of the present disclosure.

FIG. 4 is a schematic flowchart of a method for transmitting a PSFCH provided by another embodiment of the present disclosure.

FIG. 5 is a schematic flowchart of a method for transmitting a PSFCH provided by another embodiment of the present disclosure.

FIG. 6 is a schematic flowchart of a method for transmitting a PSFCH provided by another embodiment of the present disclosure.

FIG. 7 is a schematic diagram of a structure of a device for transmitting a PSFCH provided by one embodiment of the present disclosure.

FIG. 8 is a block diagram of a terminal provided by one embodiment of the present disclosure.

FIG. 9 is a block diagram of a network device provided by one embodiment of the present disclosure.

### DETAILED DESCRIPTION OF THE INVENTION

Examples will be illustrated in detail herein, which are represented in the accompanying drawings. Upon referring to the accompanying drawings in the following description, unless otherwise indicated, the same numbers in different accompanying drawings represent the same or similar elements. Implementations described in the following examples do not represent all implementations consistent with the embodiments of the present disclosure. Rather, they are merely examples of devices and methods that are consistent with certain aspects of the embodiments of the present disclosure, as detailed in the appended claims.

Terms used in the embodiments of the present disclosure are merely intended to describe specific embodiments rather than limiting the embodiments of the present disclosure. Singular forms, “a/an” and “the,” used in the embodiments and the appended claims of the present disclosure are also intended to include plural forms, unless other meanings are clearly indicated in contexts. It is further to be understood that the term “and/or” used herein refers to and includes any or all possible combinations of one or more associated items listed.

It is to be understood that although terms such as “first,” “second,” and “third” may be adopted in the embodiments of the present disclosure to describe various information, the information is not limited by such terms. Such terms are merely intended to distinguish the same type of information from one another. For example, without departing from the scope of the embodiments of the present disclosure, first information may also be referred to as second information, and similarly, the second information may also be referred to as the first information. Depending on the context, words such as “if” and “when” used herein may be interpreted as “in a case where” or “upon” or “in response to determining”.

Network elements or network functions involved in the embodiments of the present disclosure may be implemented by independent hardware devices or software in the hardware devices, which is not limited to the present disclosure.

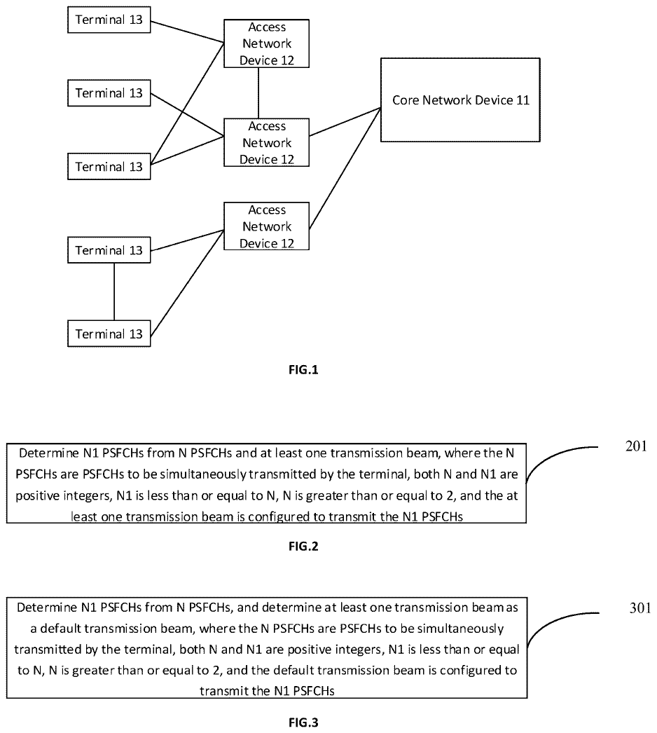

In some examples, in some embodiments, a communication system may include, for example, a terminal and a network device. The network device may include, for example, a core network device and an access network device. As shown in FIG. 1, an embodiment of the present disclosure provides a communication system, including a core network device 11 (e.g., a 5th generation core (5GC) and an evolved packet core (EPC)), an access network device 12 (e.g., a next generation node B (gNB) and an evolved node B (eNB)), and a terminal 13.

The terminal 13, also referred to as user equipment (UE), a mobile station (MS), a mobile terminal (MT), etc., is a device, which provides voice and/or data connectivity for a user, such as a handheld device with a wireless connection function and a vehicle-mounted device. Currently, some examples of the terminal include: a mobile phone, a tablet computer, a notebook computer, a palmtop computer, a mobile internet device (MID), a wearable device, a virtual reality (VR) device, an augmented reality (AR) device, a wireless terminal in the industrial control, a wireless terminal in the self-driving, a wireless terminal in the remote medical surgery, a wireless terminal in the smart grid, a wireless terminal in the transportation safety, a wireless terminal in the smart city, a wireless terminal in the smart home, etc.

The core network device 11 refers to a device in a core network (CN), which provides a service support for the terminal. For example, the core network device includes the 5th generation core (5GC) 11 and the evolved packet core (EPC) 12. Some core network devices include: an access and mobility management function (AMF), a session management function (SMF), a user plane function (UPF), and so on, which will not be exhaustively listed here. The AMF may be responsible for access management and mobility management of the terminal. The SMF may be responsible for session management, such as session establishment for the user. The UPF may be a functional entity of a user plane, which is mainly responsible for connecting to an external network.

The access network device 12 refers to a radio access network (RAN) node (or device) which access the terminal to a wireless network, and may also be referred to as a base station. For example, the access network device includes the next generation node B (gNB) and the evolved node B (eNB). Some examples of RAN nodes include: the gNB, the eNB, a transmission reception point (TRP), a radio network controller (RNC), a Node B (NB), a base station controller (BSC), a base transceiver station (BTS), a home base station (e.g., a home evolved NodeB or homenode B (HNB)), a base band unit (BBU), a wireless fidelity (Wi-Fi) access point (AP), etc. In addition, in a network structure, the access network device may include a centralized unit (CU), distributed units (DUs), or a RAN device including the CU and the DUs. The RAN device, including the CU and the DUs, splits protocol layers from the perspective of logical functions. Functions of part of the protocol layers are placed in the CU for centralized control, while functions of part or all of the remaining protocol layers are distributed in the DUs, which are centrally controlled by the CU.

It is to be understood that the communication system described in the embodiments of the present disclosure is intended to illustrate the technical solution of the embodiments of the present disclosure more clearly and does not constitute limitation of the technical solution provided by the embodiments of the present disclosure. Those of ordinary skill in the art may know that, with the evolution of the system architecture and the emergence of new service scenarios, the technical solution provided by the embodiments of the present disclosure is also applicable to similar technical problems.

The entities shown in FIG. 1 are illustrative. The implementations or embodiments of the present disclosure may include all or part of the entities in FIG. 1, or may include other entities other than those in FIG. 1. The number of the entities is arbitrary and not limited to FIG. 1. Each connection relationship shown in FIG. 1 is illustrative, and any entities may be disconnected or connected in any manners. The connection may be a direct connection or an indirect connection, or may be a wired connection or a wireless connection.

In some examples, in one embodiment of the present disclosure, the constant emergence of a new generation of novel Internet applications has put forward higher requirements for wireless communication technology, which drives the ongoing evolution of wireless communication technology to meet the demands of the applications.

In some examples, in one embodiment of the present disclosure, in order to better support vehicle-to-everything communication, LTE vehicle to everything (V2X) has been defined in the Long Term Evolution (LTE) Release 14 to support direct sidelink communication between vehicle-to everything-devices (e.g., vehicle to vehicle, vehicle to pedestrian, and vehicle to roadside node). Subsequently, the LTE V2X technology has been enhanced in Release 15, including functions such as carrier aggregation. Following the establishment of Release 15 for the New Radio (NR) technology in the 5th Generation Mobile Communication Technology (5G), the 3rd Generation Partnership Project (3GPP) initiated the work to support the vehicle-to-everything communication using an NR interface. 5G Sidelink has been completed in Release 16, supporting direct communication between vehicle-to-everything devices through the NR technology. In Release 17, the NR Sidelink has been further enhanced in aspects such as energy saving and reliability.

The support of beam management was not considered in LTE V2X and Release 16 NR V2X, as it is considered at that time that the main frequency bands for V2X applications were relatively low in frequency spectrum. With the progress and development of technology, it has become possible to perform Sidelink communication using higher millimeter-wave frequency bands. For example, analog beamforming or analog-digital hybrid beamforming is generally adopted in a case where millimeter-wave frequency bands (e.g., an FR2 frequency band) are used. In a case where both a sending terminal and a receiving terminal adopt analog beamforming, in order to obtain better communication quality, a transmission beam and a reception beam need to be paired to form a beam pair with better communication quality. As a result, beam management needs to be supported on a Sidelink.

Beam management in conventional NR Down Link (DL) or Up Link (UL) communication is carried out through reference signals, such as a downlink Synchronization Signal and PBCH block (SSB), a Channel State Information (CSI)-Reference Signal (RS), or an uplink channel Sounding Reference Signal (SRS), etc. The terminal reports a measurement report obtained according to downlink CSI-RS measurement, and the base station determines a downlink transmission beam according to the measurement report. The base station determines an uplink transmission beam for the terminal according to uplink SRS measurement, or instructs, according to channel reciprocity, the terminal to determine the uplink transmission beam according to a reception beam of a specific downlink reference signal. Since both uplink transmission and downlink transmission are controlled by the scheduling of the base station, the scheduling of the base station may ensure that neither the base station nor the terminal needs to simultaneously transmit a plurality of signals/channels needing different transmission beams that exceed its capability.

Currently, since the NR SL merely supports to simultaneously transmit either one PSCCH/PSSCH or one S-SSB, the terminal merely needs to use one transmission beam for Sidelink transmission of a Physical Sidelink Control Channel (PSCCH)/Physical Sidelink Shared Channel (PSSCH)/S-SSB at one time. However, the NR SL now supports to simultaneously transmit a plurality of PSFCHs. The plurality of PSFCHs may be multiplexed over the same Orthogonal Frequency Division Multiplexing (OFDM) symbol through Frequency-division multiplexing (FDM) or code division multiplexing (CDM), and are transmitted by the same terminal. The number of PSFCHs that may be simultaneously transmitted by the terminal is determined by the capability of the terminal. In R16/17 Sidelink, since the terminal may merely use an omnidirectional antenna for transmission, the simultaneous transmission of the plurality of PSFCHs will not cause a problem.

A method and device for transmitting a PSFCH, a device, and a storage medium provided by the embodiments of the present disclosure will be described in detail below with reference to the accompanying drawings.

FIG. 2 is a schematic flowchart of a method for transmitting a PSFCH provided by an embodiment of the present disclosure. The method is performed by a terminal. As shown in FIG. 2, the method may include the following step 201.

In step 201, N1 PSFCHs are determined from N PSFCHs, and at least one transmission beam is determined. The N PSFCHs are PSFCHs to be simultaneously transmitted by the terminal, both N and N1 are positive integers, N1 is less than or equal to N, N is greater than or equal to 2, and the at least one transmission beam is configured to transmit the N1 PSFCHs.

It is to be noted that in one embodiment of the present disclosure, the executing entity of the embodiment of the present disclosure may be, for example, the terminal. The terminal may refer to a device that provides voice and/or data connectivity for a user. The terminal may communicate with one or more core networks via a Radio Access Network (RAN). The terminal may be an Internet-of-Things terminal such as a sensor device, a mobile phone (also referred to as a cellular phone), and a computer with an Internet-of-Things terminal, for example, may be a fixed, portable, pocket-sized, handheld, computer built-in or vehicle-mounted device. For example, the terminal may be a Station (STA), a subscriber unit, a subscriber station, a mobile station, a mobile, a remote station, an access point, a remote terminal, an access terminal, a user terminal, a user agent, and User Equipment (UE). Alternatively, the terminal may also be a device for an unmanned aerial vehicle. Alternatively, the terminal may also be a vehicle-mounted device, such as an in-vehicle computer with a wireless communication function or a wireless terminal externally connected to the in-vehicle computer. Alternatively, the terminal may also be a roadside device, such as a street lamp, a traffic light, or other roadside devices with a wireless communication function.

In one embodiment of the present disclosure, the New Radio (NR) is a synchronous system. The embodiments of the present disclosure may take, for example, a slot as an example, where the slot may also be replaced by other time units, which may include, for example, a frame, a subframe, an OFDM symbol, a second, a microsecond, etc. The slot herein may be a physical slot or a logical slot. For example, all slots that may be used for SL transmission are defined as logical slots, or slots in a resource pool are defined as logical slots. The slot (n+1) is the logical slot following the slot n.

The beam herein refers to a beam, or is referred to as Spatial Relation Information, Spatial Setting, a Spatial Rx Parameter, a Tx Spatial Filter, Spatial Domain Receive Filters, a transmission configuration indication (TCI) status, a quasi co location (QCL), type D, etc.

Moreover, in one embodiment of the present disclosure, for example, N is configured to indicate the number of PSFCHs to be simultaneously transmitted by the terminal. N is not specifically referred to a fixed value. N is a positive integer and greater than 2. For example, the terminal may determine, according to a protocol, corresponding PSFCH feedback time-frequency domain positions according to time-frequency resources for transmission of PSSCHs/PSCCHs, and determine N PSFCHs that need to be fed back in the same time unit.

For example, in one embodiment of the present disclosure, N1 is configured to indicate the number of the PSFCHs to be simultaneously transmitted, determined from the N PSFCHs by the terminal. N1 is not specifically referred to a fixed value. For example, N1 may also change accordingly in a case where a method for determining N1 is changed. N1 is less than or equal to N. For example, N1 may be less than N. For example, N1 may also be equal to N.

In some embodiments, for example, the transmission beam may refer to a beam configured to transmit the PSFCHs. The at least one transmission beam is configured to transmit the N1 PSFCHs. For example, one transmission beam may be configured to transmit one PSFCH.

In one embodiment of the present disclosure, the step of determining at least one transmission beam includes the following steps.

The at least one transmission beam is determined as a default transmission beam.

For example, in one embodiment of the present disclosure, the N1 PSFCHs may be transmitted using the default transmission beam in a case where the at least one transmission beam is determined as the default transmission beam.

In one embodiment of the present disclosure, for example, the default transmission beam may be configured by the base station. For example, the default transmission beam may also be pre-defined. For example, the default transmission beam may also be pre-configured.

In one embodiment of the present disclosure, the default transmission beam includes at least one of:
an omnidirectional beam;
a transmission beam corresponding to a reception beam of a specific Sidelink-Synchronization Signal Block (S-SSB) resource; or
a transmission beam corresponding to a reception beam of a Sidelink Channel State Information-Reference Signal (SL CSI-RS) resource.

Moreover, in one embodiment of the present disclosure, for example, the default transmission beam may be the omnidirectional beam. For example, the terminal may transmit the N1 PSFCHs using the omnidirectional beam. For example, the omnidirectional beam may be a beam corresponding to an omnidirectional antenna.

For example, in one embodiment of the present disclosure, the default beam may be the transmission beam corresponding to the reception beam of the specific S-SSB resource or the SL CSI-RS resource.

For example, in one embodiment of the present disclosure, the default beam may be the transmission beam corresponding to the reception beam of the specific S-SSB resource.

For example, in one embodiment of the present disclosure, the default beam may be the transmission beam corresponding to the reception beam of the SL CSI-RS resource.

Moreover, in one embodiment of the present disclosure, the step of determining the N1 PSFCHs from the N PSFCHs includes the following steps.

The maximum number M1 of PSFCHs supported to be simultaneously transmitted using the default transmission beam is determined, where M1 is a positive integer and less than or equal to N.

The N1 PSFCHs are selected from the N PSFCHs, where N1 is less than or equal to M1.

In one embodiment of the present disclosure, M1 is configured to indicate the maximum number of the PSFCHs supported to be simultaneously transmitted using the default transmission beam. The maximum number M1 is a positive integer. For example, the maximum number M1 may be a pre-defined fixed value or determined according to the capability of the terminal. In a case where it is determined according to the capability of the terminal, the maximum number M1 may be determined, for example, through pre-configuration or by receiving downlink control signaling from the base station.

For example, in one embodiment of the present disclosure, the maximum number M1 may be the pre-defined fixed value.

For example, in one embodiment of the present disclosure, the maximum number M1 may be determined through the pre-configuration.

For example, in one embodiment of the present disclosure, the maximum number M1 may be determined through receiving the downlink control signaling from the base station.

For example, in one embodiment of the present disclosure, the step of selecting the N1 PSFCHs from the N PSFCHs includes the following step.

The N1 PSFCHs are selected from the N PSFCH in a descending order of PSFCH transmission priorities.

For example, in one embodiment of the present disclosure, in a case where N is greater than M1, the N1 (not exceeding M) PSFCHs may be selected for transmission in an order of the PSFCH transmission priorities. For example, the N1 PSFCHs may equally share the maximum transmission power of the terminal.

For example, in one embodiment of the present disclosure, in the case where N is greater than M1, the N1 (not exceeding M) PSFCHs may be selected for transmission in the order of the PSFCH transmission priorities, and the other PSFCHs may be discarded.

In one embodiment of the present disclosure, the step of determining the N1 PSFCHs from the N PSFCHs includes the following steps.

The minimum power P1 used when transmitting one PSFCH using the default transmission beam is determined.

The N1 PSFCHs are determined from the N PSFCHs according to the minimum power and the maximum transmission power Pmax of the terminal.

For example, in one embodiment of the present disclosure, the product of N1 and P1 is less than or equal to Pmax.

Moreover, in one embodiment of the present disclosure, the N1 PSFCHs may be transmitted and the other PSFCHs may be discarded in a case where the N1 PSFCHs are determined from the N PSFCHs.

In one embodiment of the present disclosure, the step of determining at least one transmission beam includes the following steps.

The number M2 of transmission beams supported to be simultaneously used by the terminal is determined.

The at least one transmission beam is determined according to the number M2 of the transmission beams.

Moreover, in one embodiment of the present disclosure, M2 is configured to indicate the number of the transmission beams supported to be simultaneously used by the terminal. M2 may be a pre-defined fixed value. M2 does not specifically refer to a fixed value. For example, M2 may be 1, 2, or 4.

For example, in one embodiment of the present disclosure, M2 may depend on the capability of the terminal. The capability of the terminal may be reported to the base station through uplink control signaling, or transmitted to other terminals through sidelink control signaling.

In one embodiment of the present disclosure, the step of determining the number M2 of the transmission beams to be simultaneously used by the terminal includes the following steps.

The number M2 of the transmission beams supported to be simultaneously used by the terminal is determined according to at least one of:
the capability of the terminal;
pre-configuration information of the terminal;
received control information transmitted by a base station or a network device; or
implementation of the terminal.

In one implementation of the present disclosure, for example, the pre-configuration information may be directly configured in the terminal. For example, the pre-configuration information may include M2.

For example, in one embodiment of the present disclosure, the number M2 of the transmission beams supported to be simultaneously used by the terminal may be determined according to the capability of the terminal.

For example, in one embodiment of the present disclosure, the number M2 of the transmission beams supported to be simultaneously used by the terminal may be determined according to the pre-configuration information of the terminal.

For example, in one embodiment of the present disclosure, the number M2 of the transmission beams supported to be simultaneously used by the terminal may be determined according to the received control information transmitted by the base station or the network device.

For example, in one embodiment of the present disclosure, the number M2 of the transmission beams supported to be simultaneously used by the terminal may be determined according to the received control information transmitted by the base station.

For example, in one embodiment of the present disclosure, the number M2 of the transmission beams supported to be simultaneously used by the terminal may be determined according to the received control information transmitted by the network device.

For example, in one embodiment of the present disclosure, the number M2 of the transmission beams supported to be simultaneously used by the terminal may be determined according to the implementation of the terminal.

In one embodiment of the present disclosure, for example, the implementation may refer to a case that does not specified by the protocol, and terminals of different manufacturers may have different implementation schemes.

In one embodiment of the present disclosure, the step of determining at least one transmission beam includes at least one of the following steps.

The at least one transmission beam is determined according to at least one of the transmission beams of PSCCHs corresponding to the N1 PSFCHs or reception beams of the PSCCHs; or
the at least one transmission beam is determined according to at least one of the transmission beams of PSSCHs corresponding to the N1 PSFCHs or reception beams of the PSSCHs.

For example, in one embodiment of the present disclosure, the at least one transmission beam is determined according to at least one of the transmission beams of the PSCCHs corresponding to the N1 PSFCHs or the reception beams of the PSCCHs.

For example, in one embodiment of the present disclosure, the at least one transmission beam is determined according to at least one of the transmission beams of the PSSCHs corresponding to the N1 PSFCHs or the reception beams of the PSSCHs.

In one embodiment of the present disclosure, the method further includes the following step.

N1 is determined according to M2, where N1 is less than or equal to M2.

In one embodiment of the present disclosure, N1 is less than or equal to M2.

For example, in one embodiment of the present disclosure, the N1 PSFCHs may be determined from the N PSFCHs in a case where N1 is determined according to M2.

For example, in one embodiment of the present disclosure, the method includes at least one of the following steps.

N1 is determined as the minimum value among N, M2, and M3, where M3 is configured to indicate the number of the PSFCHs supported to be simultaneously transmitted by the terminal, and M2 is less than M3;
N1 is determined as the minimum value among N, M2, and M4, where M4 is configured to indicate the maximum number of the PSFCHs supported to be simultaneously transmitted by the terminal; or
it is determined, according to the minimum transmission power Pi corresponding to any PSFCH of the N PSFCHs and the maximum transmission power Pmax of the terminal, that the sum of minimum transmission powers corresponding to the N1 PSFCHs of the N PSFCHs does not exceed Pmax.

For example, in one embodiment of the present disclosure, M3 is configured to indicate the number of the PSFCHs supported to be simultaneously transmitted by the terminal. The value of M3 depends on the capability of the terminal.

For example, in one embodiment of the present disclosure, the product of M4 and the minimum power P2 of the terminal for transmitting one PSFCH is less than or equal to the maximum transmission power Pmax of the terminal.

For example, in one embodiment of the present disclosure, M4 is configured to indicate the maximum number of the PSFCHs supported to be simultaneously transmitted by the terminal. The minimum power P2 for transmitting one PSFCH may be determined in a case where M2 is less than the number M3 of the PSFCHs supported to be simultaneously transmitted by the terminal. The maximum number M4 of the PSFCHs supported to be simultaneously transmitted by the terminal is determined according to the minimum power P2 for transmitting one PSFCH and the maximum transmission power Pmax of the terminal, and N1 is determined as the minimum value among N, M2, and M4. For example, the value of N1 is the minimum value among N, M2, and M4. In some examples, the transmission powers of the N1 PSFCHs equally share the maximum transmission power Pmax of the terminal.

For example, in one embodiment of the present disclosure, for the N PSFCHs, the minimum transmission power Pi corresponding to the i-th PSFCH of the N PSFCHs may be determined. It is determined that the sum of the minimum transmission powers corresponding to the N1 PSFCHs of the N PSFCHs does not exceed Pmax in response to the determined minimum transmission power Pi corresponding to the i-th PSFCH of the N PSFCHs and the maximum transmission power Pmax of the terminal. For example, the N1 PSFCHs may be selected from the N PSFCHs according to the determined minimum transmission power Pi corresponding to the i-th PSFCH of the N PSFCHs and the maximum transmission power Pmax of the terminal, where the sum of the minimum transmission powers corresponding to the N1 PSFCHs does not exceed the maximum transmission power Pmax.

Further, in one embodiment of the present disclosure, for example, the maximum transmission power Pmax may be proportionally allocated to the N1 PSFCHs based on the minimum transmission power of each PSFCH. For example, assuming that both PSFCHᵢ and PSFCHⱼ belong to the N1 PSFCHs, the actual transmission power Pia of PSFCHᵢ divided by the actual transmission power Pja of PSFCHⱼ is equal to a ratio Pi/Pj of the minimum transmission power of PSFCHᵢ and the minimum transmission power of PSFCHⱼ, and the sum of the transmission powers of the N1 PSFCHs is equal to Pmax.

In one embodiment of the present disclosure, the method further includes the following step.

The N1 PSFCHs are selected in the descending order of the PSFCH transmission priorities.

For example, in one embodiment of the present disclosure, the PSFCH transmission priority may be determined by a priority field in Sidelink Control Information (SCI) carried in PSCCH or PSSCH transmission corresponding to a PSFCH.

For example, in one embodiment of the present disclosure, the PSFCH transmission priority may be determined by the priority field in the SCI carried in the PSCCH transmission corresponding to the PSFCH.

For example, in one embodiment of the present disclosure, the PSFCH transmission priority may be determined by the priority field in the SCI carried in the PSSCH transmission corresponding to the PSFCH.

In one embodiment of the present disclosure, the method further includes the following step.

A first set is determined, where the first set includes at least one first transmission beam group, and transmission beams in the first transmission beam group may be simultaneously used.

For example, in one embodiment of the present disclosure, “first” in the first set is merely intended to distinguish from a second set, and does not specifically refer to a certain fixed set. For example, the first set may also be changed accordingly in a case where the number of groups included in the first set is changed. For example, the first set may be a set formed by converging at least one transmission beam group, which may be simultaneously used. For example, transmission beams included in one transmission beam group in the first set may be simultaneously used.

For example, in one embodiment of the present disclosure, the transmission beams included in one transmission beam group in the first set may be transmission beams corresponding to different antenna panels, and the transmission beams may be simultaneously used.

Moreover, in one embodiment of the present disclosure, the step of determining the first set includes the following step.

The first set is determined according to at least one of:
the capability of the terminal;
the pre-configuration information of the terminal;
the received control information transmitted by the base station or the network device; or
the implementation of the terminal.

For example, in one embodiment of the present disclosure, the step of determining the N1 PSFCHs from the N PSFCHs includes the following step.

The N1 PSFCHs are determined from the N PSFCHs according to the first set, where the N1 PSFCHs correspond to one first transmission beam group in the first set.

For example, in one embodiment of the present disclosure, the step of determining the N1 PSFCHs from the N PSFCHs includes the following steps.

A transmission beam for transmitting one PSFCH of the N PSFCHs is determined.

The N1 PSFCHs are determined from the N PSFCHs, where the N1 PSFCHs correspond to one first transmission beam group in the first set.

In one embodiment of the present disclosure, one PSFCH corresponds to one transmission beam in the transmission beam group.

For example, in one embodiment of the present disclosure, the step that the transmission beam for transmitting the one PSFCH of the N PSFCHs is determined includes at least one of the following steps.

The transmission beam corresponding to the one PSFCH is determined according to at least one of a transmission beam of a PSCCH corresponding to the one PSFCH or a reception beam of the PSCCH;
the transmission beam corresponding to the one PSFCH is determined according to at least one of a transmission beam of a PSSCH corresponding to the one PSFCH or a reception beam of the PSSCH; or
the transmission beam corresponding to the one PSFCH is determined according to a sending terminal of at least one of the PSCCH corresponding to the one PSFCH or the PSSCH corresponding to the one PSFCH.

For example, in one embodiment of the present disclosure, the PSFCH carries an HARQ-Acknowledgement (ACK) feedback message of its associated PSCCH or PSSCH, and a target receiving terminal for the feedback message is a sending terminal of its associated PSCCH or PSSCH. Source ID information of the sending terminal is included in the second-stage SCI information carried in the PSCCH or PSSCH transmission associated with the PSFCH. The sending terminal of the PSFCH may select different most suitable transmission beams according to different terminals.

For example, in one embodiment of the present disclosure, the method further includes at least one of the following steps.

It is determined that N1 is not greater than M2, where M2 is configured to indicate the number of the transmission beams supported to be simultaneously used by the terminal;
it is determined that N1 is not greater than M4, where M4 is configured to indicate the maximum number of the PSFCHs supported to be simultaneously transmitted by the terminal; or
it is determined, according to the minimum transmission power Pi corresponding to any PSFCH of the N PSFCHs and the maximum transmission power Pmax of the terminal, that the sum of the minimum transmission powers corresponding to the N1 PSFCHs of the N PSFCHs does not exceed Pmax.

For example, in one embodiment of the present disclosure, the product of M4 and the minimum power P2 of the terminal for transmitting one PSFCH is less than or equal to the maximum transmission power Pmax of the terminal.

For example, in one embodiment of the present disclosure, the method may include the following step. N1 PSFCHs are selected according to a criterion of selecting the maximum number of PSFCHs, and a transmission beam group capable of supporting to transmit the maximum number of PSFCHs is selected.

For example, in one embodiment of the present disclosure, the method may include the following step. Transmission beams are selected according to PSFCH priorities, and a transmission beam group capable of supporting to transmit the maximum number of PSFCHs with the highest priorities is selected.

For example, in one embodiment of the present disclosure, the method may include the following step. A selection is made according to the criterion of selecting the maximum number of PSFCHs first, and a further selection is made according to a criterion of selecting the maximum number of PSFCHs with the highest priorities in a case where a plurality of transmission beam groups are capable of supporting the same number of PSFCHs.

For example, in one embodiment of the present disclosure, the method may include the following step. A selection is made according to the criterion of selecting the maximum number of PSFCHs with the highest priorities first, and a further selection is made according to the criterion of selecting the maximum number of PSFCHs.

In one embodiment of the present disclosure, the method further includes the following step.

A second set is determined, where the second set includes at least one second transmission beam group, and transmission beams in the second transmission beam group cannot be simultaneously used.

For example, in one embodiment of the present disclosure, determining the second set includes the following step.

The second set is determined according to at least one of:
the capability of the terminal;
the pre-configuration information of the terminal;
the received control information transmitted by the base station or the network device; or
the implementation of the terminal.

For example, in one embodiment of the present disclosure, the method further includes the following step.

The second set is determined, where the second set includes at least one second transmission beam group, and transmission beams in the second transmission beam group cannot be simultaneously used.

For example, in one embodiment of the present disclosure, the step of determining the N1 PSFCHs from the N PSFCHs includes the following steps.

A transmission beam for transmitting one PSFCH of the N PSFCHs is determined.

The N1 PSFCHs are determined from the N PSFCHs, where a transmission beam corresponding to a first PSFCH of the N1 PSFCHs and a transmission beam corresponding to a second PSFCH of the N1 PSFCHs belong to different second transmission beam groups in the second set.

For example, in one embodiment of the present disclosure, the N1 PSFCHs may be determined from the N PSFCHs according to the second set.

For example, in one embodiment of the present disclosure, the first PSFCH and the second PSFCHs are configured to indicate two different PSFCHs of the N1 PSFCHs. The first PSFCH and the second PSFCH do not specifically refer to two fixed PSFCHs.

For example, in one embodiment of the present disclosure, at most one transmission beam is selected from each group in the second set. In a case where a plurality of PSFCHs respectively correspond to a plurality of transmission beams in one group, the PSFCHs with the highest priorities and the corresponding transmission beams may be selected, and the selected PSFCHs are determined as the N1 PSFCHs. The transmission beam group corresponding to the selected PSFCHs is determined as the transmission beam for transmitting the PSFCHs.

For example, in one embodiment of the present disclosure, the step of determining determines the transmission beam for transmitting the one PSFCH of the N PSFCHs includes at least one of the following steps.

The transmission beam corresponding to the one PSFCH is determined according to at least one of a transmission beam of a PSCCH corresponding to the one PSFCH or a reception beam of the PSCCH;
the transmission beam corresponding to the one PSFCH is determined according to at least one of a transmission beam of a PSSCH corresponding to the one PSFCH or a reception beam of the PSSCH; or
the transmission beam corresponding to the one PSFCH is determined according to a sending terminal of at least one of the PSCCH corresponding to the one PSFCH or the PSSCH corresponding to the one PSFCH.

For example, in one embodiment of the present disclosure, the PSFCH carries an HARQ-ACK feedback message of its associated PSCCH or PSSCH, and a target receiving terminal for the feedback message is a sending terminal of its associated PSCCH or PSSCH. Source ID information of the sending terminal is included in the second-stage SCI information carried in the PSCCH or PSSCH transmission associated with the PSFCH. The sending terminal of the PSFCH may select different most suitable transmission beams according to different terminals.

For example, in one embodiment of the present disclosure, the step of determining the transmission beam for transmitting one PSFCH of the N PSFCHs includes the following steps.

The transmission beam corresponding to the one PSFCH is determined according to at least one of the transmission beam of the PSCCH corresponding to the one PSFCH or the reception beam of the PSCCH.

For example, in one embodiment of the present disclosure, the step of determining the transmission beam for transmitting the one PSFCH of the N PSFCHs includes the following steps.

The transmission beam corresponding to the one PSFCH is determined according to at least one of the transmission beam of the PSSCH corresponding to the one PSFCH or the reception beam of the PSSCH.

For example, in one embodiment of the present disclosure, the step of determining the transmission beam for transmitting the one PSFCH of the N PSFCHs includes the following steps.

The transmission beam corresponding to the one PSFCH is determined according to the sending terminal of at least one of the PSCCH corresponding to the PSFCH or the PSSCH corresponding to the PSFCH.

For example, in one embodiment of the present disclosure, the method further includes at least one of the following steps.

It is determined that N1 is not greater than M2, where M2 is configured to indicate the number of the transmission beams supported to be simultaneously used by the terminal;
it is determined that N1 is not greater than M4, where M4 is configured to indicate the maximum number of the PSFCHs supported to be simultaneously transmitted by the terminal; or
it is determined, according to the minimum transmission power Pi corresponding to any PSFCH of the N PSFCHs and the maximum transmission power Pmax of the terminal, that the sum of the minimum transmission powers corresponding to the N1 PSFCHs of the N PSFCHs does not exceed Pmax.

For example, in one embodiment of the present disclosure, the product of M4 and the minimum power P2 of the terminal for transmitting one PSFCH is less than or equal to the maximum transmission power Pmax of the terminal.

The implementations or embodiments of the present disclosure are not exhaustive and are merely examples of some implementations or embodiments, and cannot be construed as a specific limitation of the scope of protection of the present disclosure. Each step in one implementation or embodiment may be implemented as an independent embodiment, and each step may be arbitrarily combined, in the case of no conflict. For example, a solution obtained by omitting some steps in one implementation or embodiment may also be implemented as an independent embodiment, and the order of all the steps in one implementation or embodiment may be arbitrarily changed. In addition, alternative manners or alternative examples in one implementation or embodiment may be arbitrarily combined. In addition, various implementations or embodiments may be arbitrarily combined. For example, some or all of the steps of different implementations or embodiments may be arbitrarily combined, and one implementation or embodiment may be arbitrarily combined with alternative manners or alternative examples of other implementations or embodiments.

In some implementations or embodiments, expressions such as “in response to . . . ,” “in a case where . . . ,” “at the time of . . . ,” “when . . . ,” “in a case of . . . ,” or “if . . . ” in the present disclosure may be interchanged.

In some implementations or embodiments, expressions such as “A or B,” “A and/or B,” “at least one of A and B,” “in a case A or in another case B,” “in response to one case A or in response to another case B” in the present disclosure may include at least one of the following technical solutions according to circumstances: A is performed regardless of B, that is, A is performed in some implementations or embodiments; B is performed regardless of A, that is, B is performed in some implementations or embodiments; A and B are selectively performed, that is, A or B is selected to be performed in some implementations or embodiments; or both A and B are performed, that is, A and B are performed in some implementations or embodiments.

In some implementations or embodiments, expressions such as “including A,” “containing A,” “configured to indicate A,” and “carrying A” in the present disclosure may be interpreted as either directly carrying A or indirectly indicating A.

In summary, in the embodiments of the present disclosure, the N1 PSFCHs are determined from the N PSFCHs, and the at least one transmission beam is determined, where the N PSFCHs are PSFCHs to be simultaneously transmitted by the terminal, both N and N1 are positive integers, N1 is less than or equal to N, N is greater than or equal to 2, and the at least one transmission beam is configured to transmit the N1 PSFCHs. In the embodiments of the present disclosure, the N1 PSFCHs may be determined in a case where the terminal simultaneously transmits a plurality of PSFCHs, which reduces the case where the PSFCHs cannot be transmitted due to the inability to transmit the N PSFCHs simultaneously, and may provide a mechanism for determining the transmission beam and a mechanism for transmitting the PSFCHs. The present disclosure provides a method for processing a scenario of “PSFCH transmission”, to provide the mechanism for determining the transmission beam and the PSFCHs to be transmitted in a case where the terminal simultaneously transmits the plurality of PSFCHs. This may solve the problem that the PSFCHs cannot be transmitted in a case where the number of PSFCHs to be simultaneously transmitted exceeds the number of beams supported to be simultaneously transmitted by the terminal, and may improve the accuracy of determining the transmission beam and the accuracy of PSFCH transmission. Secondly, the duration for determining the transmission beam may be shortened, and the efficiency of transmitting the N1 PSFCHs may be improved by determining at least one transmission beam as the default transmission beam. Thirdly, the accuracy of determining the N1 PSFCHs and the accuracy of transmitting the N PSFCHs may be improved by determining the maximum number M1 of the PSFCHs supported to be simultaneously transmitted using the default transmission beam. Fourthly, the accuracy of determining the N1 PSFCHs and the accuracy of transmitting the N PSFCHs may be improved by determining the minimum power P1 used when transmitting one PSFCH using the default transmission beam. Fifthly, by determining the number M2 of the transmission beams supported to be simultaneously used by the terminal and determining the transmission beam according to the number M2 of the transmission beams, the accuracy of determining the transmission beam may be improved, the case where the N1 PSFCHs cannot be simultaneously transmitted may be reduced, and the accuracy of transmitting the N1 PSFCHs may be improved. Sixthly, the N1 PSFCHs may be determined from the N PSFCHs by determining the first set of transmission beams supported to be simultaneously used by the terminal, matching between the N1 PSFCHs and the first set may be improved, the accuracy of determining the N1 PSFCHs may be improved, the case where the N1 PSFCHs cannot be simultaneously transmitted may be reduced, and the accuracy of transmitting the N1 PSFCHs may be improved. Seventhly, the N1 PSFCHs may be determined from the N PSFCHs by determining the second set of transmission beams that are not supported to be simultaneously used by the terminal, matching between the N1 PSFCHs and the second set may be improved, the accuracy of determining the N1 PSFCHs may be improved, the case where the N1 PSFCHs cannot be simultaneously transmitted may be reduced, and the accuracy of transmitting the N1 PSFCHs may be improved.

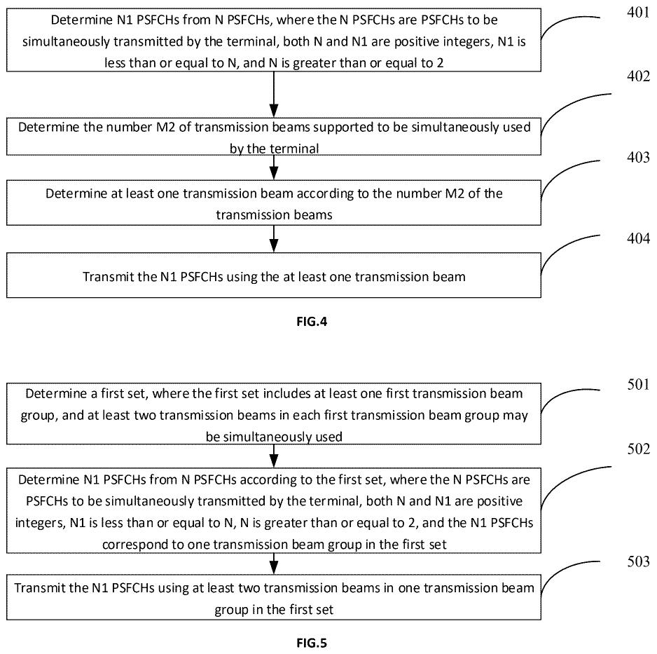

FIG. 3 is a schematic flowchart of a method for transmitting a PSFCH provided by an embodiment of the present disclosure. The method is performed by a terminal. As shown in FIG. 3, the method may include the following step 301.

In step 301, N1 PSFCHs are determined from N PSFCHs, and at least one transmission beam is determined as a default transmission beam, where the N PSFCHs are PSFCHs to be simultaneously transmitted by the terminal, both N and N1 are positive integers, N1 is less than or equal to N, N is greater than or equal to 2, and the default transmission beam is configured to transmit the N1 PSFCHs.

For example, in one embodiment of the present disclosure, the N1 PSFCHs may be transmitted using the default transmission beam in a case where the at least one transmission beam is determined as the default transmission beam.

In one embodiment of the present disclosure, for example, the default transmission beam may be configured by a base station. For example, the default transmission beam may also be pre-defined. For example, the default transmission beam may also be pre-configured.

In one embodiment of the present disclosure, the default transmission beam includes at least one of:
an omnidirectional antenna;
a transmission beam corresponding to a reception beam of a specific S-SSB resource; or
a transmission beam corresponding to a reception beam of an SL CSI-RS resource.

Moreover, in one embodiment of the present disclosure, for example, the default transmission beam may be the omnidirectional antenna. For example, the terminal may transmit the N1 PSFCHs using the omnidirectional antenna.

For example, in one embodiment of the present disclosure, the default beam may be the transmission beam corresponding to the reception beam of the specific S-SSB resource or the SL CSI-RS resource.

For example, in one embodiment of the present disclosure, the default beam may be the transmission beam corresponding to the reception beam of the specific S-SSB resource.

For example, in one embodiment of the present disclosure, the default beam may be the transmission beam corresponding to the reception beam of the SL CSI-RS resource.

Moreover, in one embodiment of the present disclosure, the step that the N1 PSFCHs are determined from the N PSFCHs includes the following steps.

The maximum number M1 of PSFCHs supported to be simultaneously transmitted using the default transmission beam is determined, where M1 is a positive integer.

The N1 PSFCHs are selected from the N PSFCHs, where N is greater than M1, and N1 is less than or equal to M1.

In one embodiment of the present disclosure, M1 is configured to indicate the maximum number of the PSFCHs supported to be simultaneously transmitted using the default transmission beam. The maximum number M1 is a positive integer. For example, the maximum number M1 may be a pre-defined fixed value or determined according to the capability of the terminal. In a case of being determined according to the capability of the terminal, the maximum number M1 may be determined, for example, through pre-configuration or receiving downlink control signaling from the base station.

For example, in one embodiment of the present disclosure, the maximum number M1 may be the pre-defined fixed value.

For example, in one embodiment of the present disclosure, the maximum number M1 may be determined through the pre-configuration.

For example, in one embodiment of the present disclosure, the maximum number M1 may be determined through receiving the downlink control signaling from the base station.

For example, in one embodiment of the present disclosure, the step of selecting the N1 PSFCHs from the N PSFCHs includes the following step.

The N1 PSFCHs are selected from the N PSFCH in a descending order of PSFCH transmission priorities.

For example, in one embodiment of the present disclosure, in a case where N is greater than M1, the N1 (not exceeding M) PSFCHs may be selected for transmission in an order of the PSFCH transmission priorities. For example, the N1 PSFCHs may equally share the maximum transmission power of the terminal.

For example, in one embodiment of the present disclosure, in the case where N is greater than M1, the N1 (not exceeding M) PSFCHs may be selected for transmission in the order of the PSFCH transmission priorities, and the other PSFCHs may be discarded.

In one embodiment of the present disclosure, the step of determining the N1 PSFCHs from the N PSFCHs includes the following steps.

The minimum power P1 used when transmitting one PSFCH using the default transmission beam is determined.

The N1 PSFCHs are determined from the N PSFCHs according to the minimum power and the maximum transmission power Pmax of the terminal.

For example, in one embodiment of the present disclosure, the product of N1 and P1 is less than or equal to Pmax.

Moreover, in one embodiment of the present disclosure, the N1 PSFCHs may be transmitted and the other PSFCHs may be discarded in a case where the N1 PSFCHs are determined from the N PSFCHs.

In one embodiment of the present disclosure, introduction of steps 301-302 may refer to the description of steps 201-202, which is not limited to the present disclosure. Alternative examples in the embodiments of the present disclosure may be arbitrarily combined, and the embodiments of the present disclosure may be combined with steps of other embodiments and alternative examples in other embodiments, in a case of no conflict.

In summary, in the embodiments of the present disclosure, the duration for determining the transmission beam may be shortened, and the efficiency of transmitting the N1 PSFCHs may be improved by determining the at least one transmission beam as the default transmission beam. Secondly, the accuracy of determining the N1 PSFCHs and the accuracy of transmitting the N PSFCHs may be improved by determining the maximum number M1 of the PSFCHs supported to be simultaneously transmitted using the default transmission beam. In addition, the accuracy of determining the N1 PSFCHs and the accuracy of transmitting the N PSFCHs may be improved by determining the minimum power P1 used when transmitting one PSFCH using the default transmission beam.

FIG. 4 is a schematic flowchart of a method for transmitting a PSFCH provided by an embodiment of the present disclosure. The method is performed by a terminal. As shown in FIG. 4, the method may include the following steps 401-404.

In step 401, N1 PSFCHs are determined from N PSFCHs, where the N PSFCHs are PSFCHs to be simultaneously transmitted by the terminal, both N and N1 are positive integers, N1 is less than or equal to N, and N is greater than or equal to 2.

In step 402, the number M2 of transmission beams supported to be simultaneously used by the terminal is determined.

In step 403, at least one transmission beam is determined according to the number M2 of the transmission beams.

In step 404, the N1 PSFCHs are transmitted using the at least one transmission beam.

Moreover, in one embodiment of the present disclosure, M2 is configured to indicate the number of the transmission beams supported to be simultaneously used by the terminal. M2 may be a pre-defined fixed value. M2 does not specifically refer to a fixed value. For example, M2 may be 1, 2, or 4.

For example, in one embodiment of the present disclosure, M2 may depend on the capability of the terminal. The capability of the terminal may be reported to a base station through uplink control signaling, or transmitted to other terminals through sidelink control signaling.

In one embodiment of the present disclosure, the step of determining the number M2 of the transmission beams to be simultaneously used by the terminal includes the following steps.

The number M2 of the transmission beams supported to be simultaneously used by the terminal is determined according to at least one of:
the capability of the terminal;
pre-configuration information of the terminal;
received control information transmitted by a base station or a network device; or
implementation of the terminal.

In one implementation of the present disclosure, for example, the pre-configuration information may be directly configured in the terminal. For example, the pre-configuration information may include M2.

For example, in one embodiment of the present disclosure, the number M2 of the transmission beams supported to be simultaneously used by the terminal may be determined according to the capability of the terminal.

For example, in one embodiment of the present disclosure, the number M2 of the transmission beams supported to be simultaneously used by the terminal may be determined according to the pre-configuration information of the terminal.

For example, in one embodiment of the present disclosure, the number M2 of the transmission beams supported to be simultaneously used by the terminal may be determined according to the received control information transmitted by the base station or the network device.

For example, in one embodiment of the present disclosure, the number M2 of the transmission beams supported to be simultaneously used by the terminal may be determined according to the received control information transmitted by the base station.

For example, in one embodiment of the present disclosure, the number M2 of the transmission beams supported to be simultaneously used by the terminal may be determined according to the received control information transmitted by the network device.

For example, in one embodiment of the present disclosure, the number M2 of the transmission beams supported to be simultaneously used by the terminal may be determined according to the implementation of the terminal.

In one embodiment of the present disclosure, for example, the implementation may refer to a case that is not specified by the protocol, and terminals of different manufacturers may have different implementation schemes.

In one embodiment of the present disclosure, the step that the at least one transmission beam is determined includes at least one of the following steps.

The at least one transmission beam is determined according to at least one of transmission beams of PSCCHs corresponding to the N1 PSFCHs or reception beams of the PSCCHs; or
the at least one transmission beam is determined according to at least one of transmission beams of PSSCHs corresponding to the N1 PSFCHs or reception beams of the PSSCHs.

For example, in one embodiment of the present disclosure, the at least one transmission beam is determined according to at least one of the transmission beams of the PSCCHs corresponding to the N1 PSFCHs or the reception beams of the PSCCHs.

For example, in one embodiment of the present disclosure, the at least one transmission beam is determined according to at least one of the transmission beams of the PSSCHs corresponding to the N1 PSFCHs or the reception beams of the PSSCHs.

In one embodiment of the present disclosure, the method further includes the following step.

N1 is determined according to M2, where N1 is less than or equal to M2.

In one embodiment of the present disclosure, N1 is less than or equal to M2.

For example, in one embodiment of the present disclosure, the N1 PSFCHs may be determined from the N PSFCHs in a case where N1 is determined according to M2.

For example, in one embodiment of the present disclosure, the method includes at least one of the following steps.

N1 is determined as the minimum value among N, M2, and M3, where M3 is configured to indicate the number of PSFCHs supported to be simultaneously transmitted by the terminal, and M2 is less than M3;
N1 is determined as the minimum value among N, M2, and M4, where M4 is configured to indicate the maximum number of the PSFCHs supported to be simultaneously transmitted by the terminal; or
it is determined, according to the minimum transmission power Pi corresponding to any PSFCH of the N PSFCHs and the maximum transmission power Pmax of the terminal, that the sum of minimum transmission powers corresponding to the N1 PSFCHs of the N PSFCHs does not exceed Pmax.

For example, in one embodiment of the present disclosure, M3 is configured to indicate the number of the PSFCHs supported to be simultaneously transmitted by the terminal. The value of M3 depends on the capability of the terminal.

For example, in one embodiment of the present disclosure, the product of M4 and the minimum power P2 of the terminal for transmitting one PSFCH is less than or equal to the maximum transmission power Pmax of the terminal.

For example, in one embodiment of the present disclosure, M4 is configured to indicate the maximum number of the PSFCHs supported to be simultaneously transmitted by the terminal. The minimum power P2 for transmitting one PSFCH may be determined in a case where M2 is less than the number M3 of the PSFCHs supported to be simultaneously transmitted by the terminal. The maximum number M4 of the PSFCHs supported to be simultaneously transmitted by the terminal is determined according to the minimum power P2 for transmitting one PSFCH and the maximum transmission power Pmax of the terminal, and N1 is determined as the minimum value among N, M2, and M4. For example, the value of N1 is the minimum value among N, M2, and M4. In some examples, the transmission powers of the N1 PSFCHs equally share the maximum transmission power Pmax of the terminal.

For example, in one embodiment of the present disclosure, for the N PSFCHs, the minimum transmission power Pi corresponding to the i-th PSFCH of the N PSFCHs may be determined. It is determined that the sum of the minimum transmission powers corresponding to the N1 PSFCHs of the N PSFCHs does not exceed Pmax in response to the determined minimum transmission power Pi corresponding to the i-th PSFCH of the N PSFCHs and the maximum transmission power Pmax of the terminal. For example, the N1 PSFCHs may be selected from the N PSFCHs according to the determined minimum transmission power Pi corresponding to the i-th PSFCH of the N PSFCHs and the maximum transmission power Pmax of the terminal, where the sum of the minimum transmission powers corresponding to the N1 PSFCHs does not exceed the maximum transmission power Pmax.

Further, in one embodiment of the present disclosure, for example, the maximum transmission power Pmax may be proportionally allocated to the N1 PSFCHs based on the minimum transmission power of each PSFCH. For example, assuming that both PSFCHᵢ and PSFCHⱼ belong to the N1 PSFCHs, the actual transmission power Pia of PSFCHᵢ divided by the actual transmission power Pja of PSFCHⱼ is equal to a ratio Pi/Pj of the minimum transmission power of PSFCHᵢ and the minimum transmission power of PSFCHⱼ, and the sum of the transmission powers of the N1 PSFCHs is equal to Pmax.

In one embodiment of the present disclosure, the method further includes the following step.

The N1 PSFCHs are selected in the descending order of the PSFCH transmission priorities.

For example, in one embodiment of the present disclosure, the PSFCH transmission priority may be determined by a priority field in SCI carried in PSCCH or PSSCH transmission corresponding to a PSFCH.

For example, in one embodiment of the present disclosure, the PSFCH transmission priority may be determined by the priority field in the SCI carried in the PSCCH transmission corresponding to the PSFCH.

For example, in one embodiment of the present disclosure, the PSFCH transmission priority may be determined by the priority field in the SCI carried in the PSSCH transmission corresponding to the PSFCH.

In one embodiment of the present disclosure, introduction of steps 401-404 may refer to the description of step 201, which is not limited to the present disclosure. Alternative examples in the embodiments of the present disclosure may be arbitrarily combined, and the embodiments of the present disclosure may be combined with steps of other embodiments and alternative examples in other embodiments, in a case of no conflict.

In summary, in the embodiments of the present disclosure, the N1 PSFCHs are determined from the N PSFCHs, where the N PSFCHs are PSFCHs to be simultaneously transmitted by the terminal, both N and N1 are positive integers, N1 is less than or equal to N, and N is greater than or equal to 2; the number M2 of the transmission beams supported to be simultaneously used by the terminal is determined; the at least one transmission beam is determined according to the number M2 of the transmission beams; and the N1 PSFCHs are transmitted using the at least one transmission beam. The present disclosure provides a method for processing a scenario of “PSFCH transmission”. By determining the number M2 of the transmission beams supported to be simultaneously used by the terminal and determining the transmission beam according to the number M2 of the transmission beams, the accuracy of determining the transmission beam may be improved, the case where the N1 PSFCHs cannot be simultaneously transmitted may be reduced, and the accuracy of transmitting the N1 PSFCHs may be improved.

FIG. 5 is a schematic flowchart of a method for transmitting a PSFCH provided by an embodiment of the present disclosure. The method is performed by a terminal. As shown in FIG. 5, the method may include the following steps 501-503.

In step 501, a first set is determined, where the first set includes at least one first transmission beam group, and at least two transmission beams in each first transmission beam group may be simultaneously used.

In step 502, N1 PSFCHs are determined from N PSFCHs according to the first set, where the N PSFCHs are PSFCHs to be simultaneously transmitted by the terminal, both N and N1 are positive integers, N1 is less than or equal to N, N is greater than or equal to 2, and the N1 PSFCHs correspond to one transmission beam group in the first set.

In step 503, the N1 PSFCHs are transmitted using at least two transmission beams in one transmission beam group in the first set.

For example, in one embodiment of the present disclosure, “first” in the first set is merely intended to distinguish from a second set, and does not specifically refer to a certain fixed set. For example, the first set may also be changed accordingly in a case where the number of groups included in the first set is changed. For example, the first set may be a set formed by converging at least one transmission beam group which may be simultaneously used. For example, transmission beams included in one transmission beam group in the first set may be simultaneously used.

For example, in one embodiment of the present disclosure, the transmission beams included in one transmission beam group in the first set may be transmission beams corresponding to different antenna panels, and the transmission beams may be simultaneously used.

Moreover, in one embodiment of the present disclosure, the step that the first set is determined includes the following step.

The first set is determined according to at least one of:
the capability of the terminal;
pre-configuration information of the terminal;
received control information transmitted by a base station or a network device; or
implementation of the terminal.

For example, in one embodiment of the present disclosure, the step that the N1 PSFCHs are determined from the N PSFCHs includes the following step.

The N1 PSFCHs are determined from the N PSFCHs according to the first set, where the N1 PSFCHs correspond to one first transmission beam group in the first set.

For example, in one embodiment of the present disclosure, the step that the N1 PSFCHs are determined from the N PSFCHs includes the following steps.

A transmission beam for transmitting one PSFCH of the N PSFCHs is determined.

The N1 PSFCHs are determined from the N PSFCHs, where the N1 PSFCHs correspond to one first transmission beam group in the first set.

In one embodiment of the present disclosure, one PSFCH corresponds to one transmission beam in the transmission beam group.

For example, in one embodiment of the present disclosure, the step of determining the transmission beam for transmitting the one PSFCH of the N PSFCHs is determined includes at least one of the following steps.

The transmission beam corresponding to the one PSFCH is determined according to at least one of a transmission beam of a PSCCH corresponding to the one PSFCH or a reception beam of the PSCCH;
the transmission beam corresponding to the one PSFCH is determined according to at least one of a transmission beam of a PSSCH corresponding to the one PSFCH or a reception beam of the PSSCH; or
the transmission beam corresponding to the one PSFCH is determined according to a sending terminal of at least one of the PSCCH corresponding to the one PSFCH or the PSSCH corresponding to the one PSFCH.

For example, in one embodiment of the present disclosure, the PSFCH carries an HARQ-ACK feedback message of its associated PSCCH or PSSCH, and a target receiving terminal for the feedback message is a sending terminal of its associated PSCCH or PSSCH. Source ID information of the sending terminal is included in second-stage SCI information carried in PSCCH or PSSCH transmission associated with the PSFCH. The sending terminal of the PSFCH may select different most suitable transmission beams according to different terminals.

For example, in one embodiment of the present disclosure, the method further includes at least one of the following steps.

It is determined that N1 is not greater than M2, where M2 is configured to indicate the number of transmission beams supported to be simultaneously used by the terminal;
it is determined that N1 is not greater than M4, where M4 is configured to indicate the maximum number of PSFCHs supported to be simultaneously transmitted by the terminal; or
it is determined, according to the minimum transmission power Pi corresponding to any PSFCH of the N PSFCHs and the maximum transmission power Pmax of the terminal, that the sum of the minimum transmission powers corresponding to the N1 PSFCHs of the N PSFCHs does not exceed Pmax.

For example, in one embodiment of the present disclosure, the product of M4 and the minimum power P2 of the terminal for transmitting one PSFCH is less than or equal to the maximum transmission power Pmax of the terminal.

For example, in one embodiment of the present disclosure, the method may include the following step. N1 PSFCHs are selected according to a criterion of selecting the maximum number of PSFCHs, and a transmission beam group capable of supporting to transmit the maximum number of PSFCHs is selected.

For example, in one embodiment of the present disclosure, the method may include the following step. Transmission beams are selected according to PSFCH priorities, and a transmission beam group capable of supporting to transmit the maximum number of PSFCHs with the highest priorities is selected.

For example, in one embodiment of the present disclosure, the method may include the following step. A selection is made according to the criterion of selecting the maximum number of PSFCHs first, and a further selection is made according to a criterion of selecting the maximum number of PSFCHs with the highest priorities in a case where a plurality of transmission beam groups are capable of supporting the same number of PSFCHs.

For example, in one embodiment of the present disclosure, the method may include the following step. A selection is made according to the criterion of selecting the maximum number of PSFCHs with the highest priorities first, and a further selection is made according to the criterion of selecting the maximum number of PSFCHs.

In one embodiment of the present disclosure, introduction of steps 501-503 may refer to the description of step 201, which is not limited to the present disclosure. Alternative examples in the embodiments of the present disclosure may be arbitrarily combined, and the embodiments of the present disclosure may be combined with steps of other embodiments and alternative examples in other embodiments, in a case of no conflict.

In summary, in the embodiments of the present disclosure, the first set is determined, where the first set includes at least one first transmission beam group, and at least two transmission beams in each first transmission beam group may be simultaneously used; the N1 PSFCHs are determined from the N PSFCHs according to the first set, where the N PSFCHs are PSFCHs to be simultaneously transmitted by the terminal, N and N1 are positive integers, N1 is less than or equal to N, N is greater than or equal to 2, and the N1 PSFCHs correspond to one transmission beam group in the first set; and the N1 PSFCHs are transmitted using at least two transmission beams in one transmission beam group in the first set. The present disclosure provides a method for processing a scenario of “PSFCH transmission”. The N1 PSFCHs may be determined from the N PSFCHs by determining the first set of transmission beams supported to be simultaneously used by the terminal, matching between the N1 PSFCHs and the first set may be improved, the accuracy of determining the N1 PSFCHs may be improved, the case where the N1 PSFCHs cannot be simultaneously transmitted may be reduced, and the accuracy of transmitting the N1 PSFCHs may be improved.

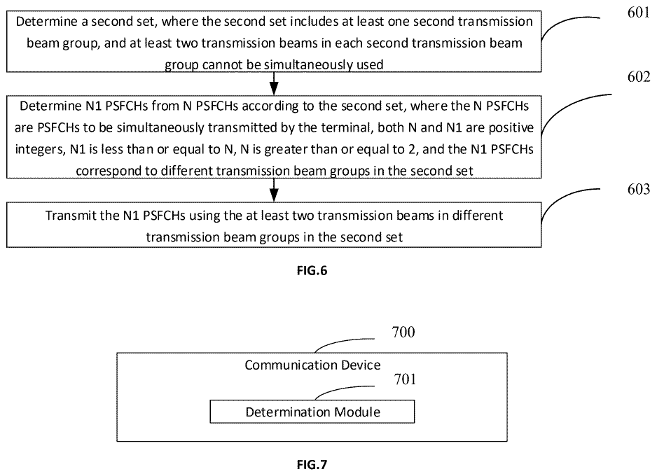

FIG. 6 is a schematic flowchart of a method for transmitting a PSFCH provided by an embodiment of the present disclosure. The method is performed by a terminal. As shown in FIG. 6, the method may include the following steps 601-603.

In step 601, a second set is determined, where the second set includes at least one second transmission beam group, and at least two transmission beams in each second transmission beam group cannot be simultaneously used.

In step 602, N1 PSFCHs are determined from N PSFCHs according to the second set, where the N PSFCHs are PSFCHs to be simultaneously transmitted by the terminal, both N and N1 are positive integers, N1 is less than or equal to N, N is greater than or equal to 2, and the N1 PSFCHs correspond to different transmission beam groups in the second set.

In step 603, the N1 PSFCHs are transmitted using at least two transmission beams in different transmission beam groups in the second set.

The second set is determined according to at least one of:
the capability of the terminal;
pre-configuration information of the terminal;
received control information transmitted by a base station or a network device; or
implementation of the terminal.

For example, in one embodiment of the present disclosure, the method further includes the following step.

The second set is determined, where the second set includes at least one second transmission beam group, and transmission beams in the second transmission beam group cannot be simultaneously used.

For example, in one embodiment of the present disclosure, the step of determining the N1 PSFCHs from the N PSFCHs includes the following steps.

A transmission beam for transmitting one PSFCH of the N PSFCHs is determined.

The N1 PSFCHs are determined from the N PSFCHs, where a transmission beam corresponding to a first PSFCH of the N1 PSFCHs and a transmission beam corresponding to a second PSFCH of the N1 PSFCHs belong to different second transmission beam groups in the second set.

For example, in one embodiment of the present disclosure, the N1 PSFCHs may be determined from the N PSFCHs according to the second set.

For example, in one embodiment of the present disclosure, the first PSFCH and the second PSFCH are configured to indicate two different PSFCHs of the N1 PSFCHs. The first PSFCH and the second PSFCH do not specifically refer to two fixed PSFCHs.

For example, in one embodiment of the present disclosure, at most one transmission beam is selected from each group in the second set. In a case where a plurality of PSFCHs respectively correspond to a plurality of transmission beams in one group, the PSFCHs with the highest priorities and the corresponding transmission beams may be selected, and the selected PSFCHs are determined as the N1 PSFCHs. The transmission beam group corresponding to the selected PSFCHs is determined as the transmission beam for transmitting the PSFCHs.

For example, in one embodiment of the present disclosure, the step that determines the transmission beam for transmitting the one PSFCH of the N PSFCHs includes at least one of the following steps.

The transmission beam corresponding to the one PSFCH is determined according to at least one of a transmission beam of a PSCCH corresponding to the one PSFCH or a reception beam of the PSCCH;
the transmission beam corresponding to the one PSFCH is determined according to at least one of a transmission beam of a PSSCH corresponding to the one PSFCH or a reception beam of the PSSCH; or
the transmission beam corresponding to the one PSFCH is determined according to a sending terminal of at least one of the PSCCH corresponding to the one PSFCH or the PSSCH corresponding to the one PSFCH.

For example, in one embodiment of the present disclosure, the PSFCH carries an HARQ-ACK feedback message of its associated PSCCH or PSSCH, and a target receiving terminal for the feedback message is a sending terminal of its associated PSCCH or PSSCH. Source ID information of the sending terminal is included in second-stage SCI information carried in PSCCH or PSSCH transmission associated with the PSFCH. The sending terminal of the PSFCH may select different most suitable transmission beams according to different terminals.

For example, in one embodiment of the present disclosure, the step of determining the transmission beam for transmitting the one PSFCH of the N PSFCHs includes the following steps.

The transmission beam corresponding to the one PSFCH is determined according to at least one of the transmission beam of the PSCCH corresponding to the one PSFCH or the reception beam of the PSCCH.

For example, in one embodiment of the present disclosure, the step of determining the transmission beam for transmitting the one PSFCH of the N PSFCHs includes the following steps.

The transmission beam corresponding to the one PSFCH is determined according to at least one of the transmission beam of the PSSCH corresponding to the one PSFCH or the reception beam of the PSSCH.

For example, in one embodiment of the present disclosure, the step of determining the transmission beam for transmitting the one PSFCH of the N PSFCHs includes the following steps.

The transmission beam corresponding to the one PSFCH is determined according to the sending terminal of at least one of the PSCCH corresponding to the PSFCH or the PSSCH corresponding to the PSFCH.

For example, in one embodiment of the present disclosure, the method further includes at least one of the following steps.

It is determined that N1 is not greater than M2, where M2 is configured to indicate the number of transmission beams supported to be simultaneously used by the terminal;
it is determined that N1 is not greater than M4, where M4 is configured to indicate the maximum number of PSFCHs supported to be simultaneously transmitted by the terminal; or
it is determined, according to the minimum transmission power Pi corresponding to any PSFCH of the N PSFCHs and the maximum transmission power Pmax of the terminal, that the sum of minimum transmission powers corresponding to the N1 PSFCHs of the N PSFCHs does not exceed Pmax.

For example, in one embodiment of the present disclosure, the product of M4 and the minimum power P2 of the terminal for transmitting one PSFCH is less than or equal to the maximum transmission power Pmax of the terminal.

In one embodiment of the present disclosure, introduction of steps 601-603 may refer to the description of step 201, which is not limited to the present disclosure. Alternative examples in the embodiments of the present disclosure may be arbitrarily combined, and the embodiments of the present disclosure may be combined with steps of other embodiments and alternative examples in other embodiments, in a case of no conflict.

In summary, in the embodiments of the present disclosure, the second set is determined, where the second set includes at least one second transmission beam group, and at least two transmission beams in each second transmission beam group cannot be simultaneously used; the N1 PSFCHs are determined from the N PSFCHs according to the second set, where the N PSFCHs are PSFCHs to be simultaneously transmitted by the terminal, N and N1 are positive integers, N1 is less than or equal to N, and N is greater than or equal to 2, and the N1 PSFCHs correspond to different transmission beam groups in the second set; and the N1 PSFCHs are transmitted using at least two transmission beams in different transmission beam groups in the second set. The present disclosure provides a method for processing a scenario of “PSFCH transmission”. The N1 PSFCHs may be determined from the N PSFCHs by determining the second set of transmission beams that are not supported to be simultaneously used by the terminal, matching between the N1 PSFCHs and the second set may be improved, the accuracy of determining the N1 PSFCHs may be improved, the case where the N1 PSFCHs cannot be simultaneously transmitted may be reduced, and the accuracy of transmitting the N1 PSFCHs may be improved.

For example, in one embodiment of the present disclosure, in a case where the terminal needs to simultaneously transmit N PSFCHs, N1 PSFCHs are determined from the N PSFCHs, and a transmission beam is determined. The terminal may transmit the PSFCHs using the transmission beam.

In some examples, in one embodiment of the present disclosure, for example, a specific default transmission beam may be used for transmission, where the default transmission beam may be configured by a base station, pre-defined, or pre-configured. For example, an omnidirectional antenna may be used for transmission by default, or the default beam may be a transmission beam corresponding to a reception beam of a specific S-SSB resource or an SL CSI-RS resource.

In some examples, in one embodiment of the present disclosure, the maximum number M of PSFCHs that may be supported to be simultaneously transmitted in a case of using the default transmission beam is determined. The maximum number may be a pre-defined fixed value, or obtained through pre-configuration or receiving downlink control signaling from the base station, depending on a capability of the terminal. In a case where N is greater than M, N1 (not exceeding M) PSFCHs are selected for transmission in an order of priorities corresponding to the PSFCHs. In some examples, transmission of the other PSFCHs is discarded. Transmission powers of the N1 PSFCHs equally share the maximum transmission power of the UE.

In some examples, in one embodiment of the present disclosure, the minimum power P1 used when transmitting one PSFCH using the default transmission beam is determined. The N1 PSFCHs are determined to be transmitted according to the minimum power and the maximum transmission power Pmax of the terminal, where N1*P1 is less than or equal to Pmax. Transmission of the other PSFCHs is discarded.

In some examples, in one embodiment of the present disclosure, the number M of transmission beams supported to be simultaneously used by the terminal is determined. The value of M may be a pre-defined fixed value, such as 1, 2 or 4; or depends on the capability of the terminal. The capability of the terminal may be reported to the base station through uplink control signaling or transmitted to other terminals through sidelink control signaling.

In some examples, in one embodiment of the present disclosure, a PSFCH transmission beam may be determined according to a transmission beam and/or a reception beam of its corresponding PSCCH/PSSCH.

In some examples, in one embodiment of the present disclosure, the value of N1 and N1 PSFCHs are determined according to M, where N1 is less than or equal to M.

In some examples, in one embodiment of the present disclosure, the N1 PSFCHs are transmitted using the transmission beam corresponding to the N1 PSFCHs.

In some examples, in one embodiment of the present disclosure, M is less than the number M1 of the PSFCHs supported to be simultaneously transmitted by the UE. The value of M1 depends on the capability of the UE, and N1 takes the minimum value among N, M, and M1.

In some examples, in one embodiment of the present disclosure, on the basis of the above embodiments, the minimum transmission power P1 for transmitting one PSFCH is determined, and the maximum number M2 of the PSFCHs supported to be simultaneously transmitted by the UE is determined according to P1 and the maximum transmission power Pmax of the UE. N1 takes the minimum value among N, M, and M2. In some examples, the transmission powers of the N1 PSFCHs equally share Pmax.

In some examples, in one embodiment of the present disclosure, on the basis of the above embodiments, for the i-th PSFCH of the N PSFCHs, the minimum transmission power Pi for the i-th PSFCH is determined according to its corresponding transmission beam, and N1 PSFCHs are selected according to Pi and the maximum transmission power Pmax of the UE, such that the sum of the minimum transmission powers corresponding to the N1 PSFCHs does not exceed Pmax. In some examples, Pmax is proportionally allocated to the N1 PSFCHs according to the minimum transmission power of each PSFCH. In other words, assuming that both PSFCHi and PSFCHj belong to the N1 PSFCHs, a ratio Pia/Pja of their actual transmission powers is equal to a ratio Pi/Pj of their minimum transmission powers, and the sum of the transmission powers of the N1 PSFCHs is equal to Pmax.

In some examples, in one embodiment of the present disclosure, the N1 PSFCHs are selected in a descending order of transmission priorities corresponding to the PSFCHs in the above embodiments, and the priorities corresponding to the PSFCHs are determined according to a priority field in SCI carried in PSCCH/PSSCH transmission corresponding to the PSFCHs.

In some examples, in one embodiment of the present disclosure, a group set of the transmission beams supported to be simultaneously used by the terminal is determined. N1 transmission beams are determined according to the group set and transmitted.

In some examples, in one embodiment of the present disclosure, the terminal determines a group of the transmission beams supported to be simultaneously used according to its own capability or implementation. For example, transmission beams corresponding to different antenna panels may be simultaneously used.

In some examples, in one embodiment of the present disclosure, N1 PSFCHs are selected, and the N1 PSFCHs belong to the same transmission beam group.

In some examples, in one embodiment of the present disclosure, N1 PSFCHs are selected according to a criterion of selecting the maximum number of PSFCHs, and a transmission beam group capable of supporting to transmit the maximum number of PSFCHs is selected.

In some examples, in one embodiment of the present disclosure, transmission beams are selected according to PSFCH priorities, and a transmission beam group capable of supporting to transmit the maximum number of PSFCHs with the highest priorities is selected.

In some examples, in one embodiment of the present disclosure, with a combination of the above embodiments, for example, a selection is made according to the criterion of selecting the maximum number of PSFCHs first, and a further selection is then made according to the criterion of selecting the maximum number of PSFCHs with the highest priorities in a case where a plurality of transmission beam groups are capable of supporting the same number of PSFCHs. Alternatively, a selection is made according to the criterion of selecting the maximum number of PSFCHs with the highest priorities first, and a further selection is then made according to the criterion of selecting the maximum number of PSFCHs.

In some examples, in one embodiment of the present disclosure, a group set of transmission beams that are not supported to be simultaneously used by the terminal is determined. For example, transmission beams corresponding to the same antenna panel cannot be simultaneously used.

In some examples, in one embodiment of the present disclosure, N1 PSFCHs are selected, and any two PSFCHs of the N1 PSFCHs do not belong to the same group.

In some examples, in one embodiment of the present disclosure, at most one transmission beam is selected from each group in the set. The PSFCHs with the highest priorities and the corresponding transmission beam are selected in a case where a plurality of PSFCHs respectively correspond to a plurality of transmission beams in one group. The selected PSFCHs are determined as the N1 PSFCHs, and the transmission beam group corresponding to the selected PSFCHs is determined as the transmission beam for transmitting the PSFCHs.

It is to be noted that the various embodiments shown in FIGS. 3 to 6 above may be separately implemented, or may be combined in a case of no conflict in the solutions. The combination includes a combination of various embodiments, and may also include a combination of one or some steps in the embodiments, and the specific manner of the combination is not limited in the present application.

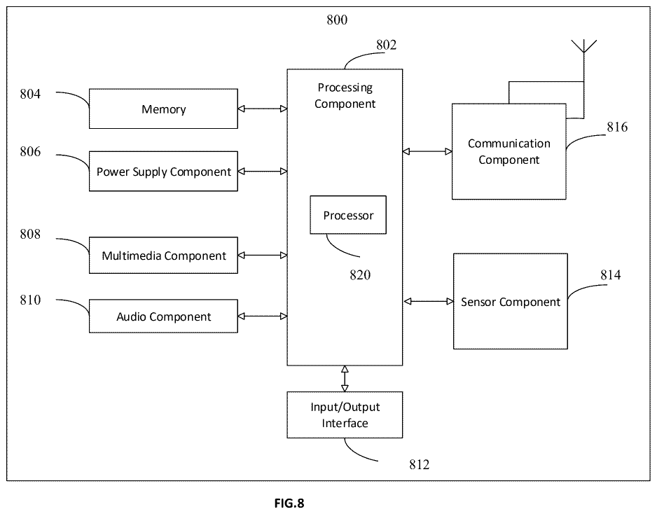

FIG. 7 is a schematic diagram of a structure of a communication device provided by an embodiment of the present disclosure. As shown in FIG. 7, the communication device 700 may include:

a determination module 701, configured to determine N1 PSFCHs from N PSFCHs and at least one transmission beam. The N PSFCHs are PSFCHs to be simultaneously transmitted by the terminal, both N and N1 are positive integers, N1 is less than or equal to N, N is greater than or equal to 2, and the at least one transmission beam is configured to transmit the N1 PSFCHs.

In summary, in the device for transmitting the PSFCH of the embodiment of the present disclosure, the determination module is configured to determine the N1 PSFCHs from the N PSFCHs and the at least one transmission beam, where the N PSFCHs are PSFCHs to be simultaneously transmitted by the terminal, both N and N1 are positive integers, N1 is less than or equal to N, N is greater than or equal to 2, and the at least one transmission beam is configured to transmit the N1 PSFCHs. In the embodiment of the present disclosure, the N1 PSFCHs may be determined in a case where the terminal simultaneously transmits a plurality of PSFCHs, which reduces the case where the PSFCHs cannot be transmitted due to inability to transmit the N PSFCHs simultaneously, and may provide a mechanism for determining the transmission beam and a mechanism for transmitting the PSFCHs. The present disclosure provides a method for processing a scenario of “PSFCH transmission”, to provide the mechanism for determining the transmission beam and the PSFCHs to be transmitted in a case where the terminal simultaneously transmits the plurality of PSFCHs. This may solve the problem that the PSFCHs cannot be transmitted in a case where the number of PSFCHs to be simultaneously transmitted exceeds the number of beams supported to be simultaneously transmitted by the terminal, and may improve the accuracy of determining the transmission beam and the accuracy of PSFCH transmission.

In some examples, in one embodiment of the present disclosure, the determination module 701, when configured to determine the at least one transmission beam, is specifically configured to:
determine the at least one transmission beam as a default transmission beam.

In some examples, in one embodiment of the present disclosure, the default transmission beam includes at least one of:
an omnidirectional beam;
a transmission beam corresponding to a reception beam of a specific S-SSB resource; or
a transmission beam corresponding to a reception beam of an SL CSI-RS resource.

In some examples, in one embodiment of the present disclosure, the determination module 701, when configured to determine the N1 PSFCHs from the N PSFCHs, is specifically configured to:
determine the maximum number M1 of PSFCHs supported to be simultaneously transmitted using the default transmission beam, where M1 is a positive integer and M1 is less than or equal to N; and
select the N1 PSFCHs from the N PSFCHs, where N1 is less than or equal to M1.

In some examples, in one embodiment of the present disclosure, the determination module 701, when configured to select the N1 PSFCHs from the N PSFCHs, is specifically configured to:
select the N1 PSFCHs from the N PSFCHs in a descending order of PSFCH transmission priorities.

In some examples, in one embodiment of the present disclosure, the determination module 701, when configured to determine the N1 PSFCHs from the N PSFCHs, is specifically configured to:
determine the minimum power P1 used when transmitting one PSFCH using the default transmission beam; and
determine the N1 PSFCHs from the N PSFCHs according to the minimum power and the maximum transmission power Pmax of the terminal.

In some examples, in one embodiment of the present disclosure, the product of N1 and P1 is less than or equal to Pmax.

In some examples, in one embodiment of the present disclosure, the determination module 701, when configured to determine the at least one transmission beam, is specifically configured to:
determine the number M2 of transmission beams supported to be simultaneously used by the terminal; and
determine the at least one transmission beam according to the number M2 of the transmission beams.

In some examples, in one embodiment of the present disclosure, the determination module 701, when configured to determine the number M2 of the transmission beams supported to be simultaneously used by the terminal, is specifically configured to:
determine the number M2 of the transmission beams supported to be simultaneously used by the terminal according to at least one of:
the capability of the terminal;
pre-configuration information of the terminal;
received control information transmitted by a base station or a network device; or implementation of the terminal.

In some examples, in one embodiment of the present disclosure, the determination module 701, when configured to determine the at least one transmission beam, is specifically configured to determine at least one of:
the at least one transmission beam according to at least one of transmission beams of PSCCHs corresponding to the N1 PSFCHs or reception beams of the PSCCHs; or
the at least one transmission beam according to at least one of transmission beams of PSSCHs corresponding to the N1 PSFCHs or reception beams of the PSSCHs.

In some examples, in one embodiment of the present disclosure, N1 is less than or equal to M2.

In some examples, in one embodiment of the present disclosure, the determination module 701 is further configured to determine at least one of:
N1 as the minimum value among N, M2, and M3, where M3 is configured to indicate the number of the PSFCHs supported to be simultaneously transmitted by the terminal, and M2 is less than M3;
N1 as the minimum value among N, M2, and M4, where M4 is configured to indicate the maximum number of the PSFCHs supported to be simultaneously transmitted by the terminal; or
according to the minimum transmission power Pi corresponding to any PSFCH of the N PSFCHs and the maximum transmission power Pmax of the terminal, that the sum of minimum transmission powers corresponding to the N1 PSFCHs of the N PSFCHs does not exceed Pmax.

In some examples, in one embodiment of the present disclosure, the product of M4 and the minimum power P2 of the terminal for transmitting one PSFCH is less than or equal to the maximum transmission power Pmax of the terminal.

In some examples, in one embodiment of the present disclosure, the determination module 701 is further configured to:
select the N1 PSFCHs in the descending order of PSFCH transmission priorities.

In some examples, in one embodiment of the present disclosure, the determination module 701 is further configured to:
determine a first set, where the first set includes at least one first transmission beam group, and transmission beams in the first transmission beam group may be simultaneously used.

In some examples, in one embodiment of the present disclosure, the determination module 701, when configured to determine the N1 PSFCHs from the N PSFCHs, is specifically configured to:
determine the N1 PSFCHs from the N PSFCHs according to the first set, where the N1 PSFCHs correspond to one first transmission beam group in the first set.

In some examples, in one embodiment of the present disclosure, the determination module 701, when configured to determine the N1 PSFCHs from the N PSFCHs according to the first set, is specifically configured to:
determine a transmission beam corresponding to one PSFCH of the N PSFCHs; and
determine the N1 PSFCHs from the N PSFCHs, where transmission beams corresponding to the N1 PSFCHs belong to one first transmission beam group in the first set.

In some examples, in one embodiment of the present disclosure, the determination module 701, when configured to determine the transmission beam for transmitting the one PSFCH of the N PSFCHs, is specifically configured to determine at least one of:
the transmission beam corresponding to the one PSFCH according to at least one of a transmission beam of a PSCCH corresponding to the one PSFCH or a reception beam of the PSCCH;
the transmission beam corresponding to the one PSFCH according to at least one of a transmission beam of a PSSCH corresponding to the one PSFCH or a reception beam of the PSSCH; or
the transmission beam corresponding to the one PSFCH according to a sending terminal of at least one of the PSCCH corresponding to the one PSFCH or the PSSCH corresponding to the one PSFCH.

In some examples, in one embodiment of the present disclosure, the determination module 701 is further configured to determine at least one of:
that N1 is not greater than M2, where M2 is configured to indicate the number of the transmission beams supported to be simultaneously used by the terminal;
that N1 is not greater than M4, where M4 is configured to indicate the maximum number of the PSFCHs supported to be simultaneously transmitted by the terminal; or
according to the minimum transmission power Pi corresponding to any PSFCH of the N PSFCHs and the maximum transmission power Pmax of the terminal, that the sum of minimum transmission powers corresponding to the N1 PSFCHs of the N PSFCHs does not exceed Pmax.

In some examples, in one embodiment of the present disclosure, the product of M4 and the minimum power P2 of the terminal for transmitting one PSFCH is less than or equal to the maximum transmission power Pmax of the terminal.

In some examples, in one embodiment of the present disclosure, the determination module 701 is further configured to:
determine a second set, where the second set includes at least one second transmission beam group, and transmission beams in the second transmission beam group cannot be simultaneously used.

In some examples, in one embodiment of the present disclosure, the determination module 701 is further configured to:
determine N1 as the minimum value among N, M2, and M4, where M2 is configured to indicate the number of the transmission beams supported to be simultaneously used by the terminal, and M4 is configured to indicate the maximum number of the PSFCHs supported to be simultaneously transmitted by the terminal; and
determine, according to the minimum transmission power Pi corresponding to any PSFCH of the N PSFCHs and the maximum transmission power Pmax of the terminal, that the sum of the minimum transmission powers corresponding to the N1 PSFCHs of the N PSFCHs does not exceed Pmax.

In some examples, in one embodiment of the present disclosure, the product of M4 and the minimum power P2 of the terminal for transmitting one PSFCH is less than or equal to the maximum transmission power Pmax of the terminal.

In some examples, in one embodiment of the present disclosure, the determination module 701, when configured to determine the N1 PSFCHs from the N PSFCHs, is specifically configured to:
determine the N1 PSFCHs from the N PSFCHs according to the second set, where the N1 PSFCHs correspond to different second transmission beam groups in the second set.

In some examples, in one embodiment of the present disclosure, the determination module 701, when configured to determine the N1 PSFCHs from the N PSFCHs according to the second set, is specifically configured to:
determine a transmission beam for transmitting one PSFCH of the N PSFCHs; and
determine the N1 PSFCHs from the N PSFCHs, where a transmission beam corresponding to a first PSFCH of the N1 PSFCHs and a transmission beam corresponding to a second PSFCH of the N1 PSFCHs belong to different second transmission beam groups in the second set.

In some examples, in one embodiment of the present disclosure, the determination module 701, when configured to determine the transmission beam for transmitting the one PSFCH of the N PSFCHs, is specifically configured to determine at least one of:
the transmission beam corresponding to the one PSFCH according to at least one of a transmission beam of a PSCCH corresponding to the one PSFCH or a reception beam of the PSCCH;
the transmission beam corresponding to the one PSFCH according to at least one of a transmission beam of a PSSCH corresponding to the one PSFCH or a reception beam of the PSSCH; or
the transmission beam corresponding to the one PSFCH according to a sending terminal of at least one of the PSCCH corresponding to the one PSFCH and the PSSCH corresponding to the one PSFCH.

In some examples, in one embodiment of the present disclosure, the determination module 701 is further configured to:
determine that N1 is not greater than M2, where M2 is configured to indicate the number of the transmission beams supported to be simultaneously used by the terminal;
determine that N1 is not greater than M4, where M4 is configured to indicate the maximum number of the PSFCHs supported to be simultaneously transmitted by the terminal; and
determine, according to the minimum transmission power Pi corresponding to any PSFCH of the N PSFCHs and the maximum transmission power Pmax of the terminal, that the sum of the minimum transmission powers corresponding to the N1 PSFCHs of the N PSFCHs does not exceed Pmax.

In some examples, in one embodiment of the present disclosure, the product of M4 and the minimum power P2 of the terminal for transmitting one PSFCH is less than or equal to the maximum transmission power Pmax of the terminal.

FIG. 8 is a block diagram of a terminal according to UE 800 provided by an embodiment of the present disclosure. For example, the UE 800 may be a mobile phone, a computer, a digital broadcasting terminal, a messaging device, a game console, a tablet device, a medical device, a fitness device, a personal digital assistant, etc.

Referring to FIG. 8, the UE 800 may include at least one of the following components: a processing component 802, a memory 804, a power supply component 806, a multimedia component 808, an audio component 810, an input/output (I/O) interface 812, a sensor component 814, or a communication component 816.

The processing component 802 typically controls the overall operation of the UE 800, such as operations associated with display, telephone calls, data communication, camera operation, and recording operation. The processing component 802 may include at least one processor 820 to execute instructions to implement all or part of the steps of the methods described above. Additionally, the processing component 802 may include at least one module to facilitate processing interaction between the processing component 802 and other components. For example, the processing component 802 may include a multimedia module to facilitate interaction between the multimedia component 808 and the processing component 802.

The memory 804 is configured to store various types of data to support the operation of the UE 800. Examples of such data include instructions for any applications or methods operating on the UE 800, contact data, phone book data, messages, pictures, videos, and the like. The memory 804 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or a compact disk.

The power supply component 806 supplies power to various components of the UE 800. The power component 806 may include a power management system, at least one power supply, and other components associated with generating, managing, and distributing power to the UE 800.

The multimedia component 808 includes a screen providing an output interface between the UE 800 and a user. In some embodiments, the screen may include a liquid crystal display (LCD) and a touch panel (TP). The screen may be implemented as a touch screen to receive an input signal from the user in a case where the screen includes the touch panel. The touch panel includes at least one touch sensor to detect touch, swipes, and gestures on the touch panel. The touch sensor may detect not only boundaries of touch or swipe actions, but also wakeup time and pressure associated with the touch or swipe operations. In some embodiments, the multimedia component 808 includes a front camera and/or a rear camera. The front camera and/or the rear camera may receive external multimedia data in a case where the UE 800 is in an operational mode, such as a shooting mode or a video mode. Each of the front camera and the rear camera may be a fixed optical lens system or may have a focal length and an optical zoom capability.

The audio component 810 is configured to output and/or input an audio signal. For example, the audio component 810 includes a microphone (MIC). The microphone is configured to receive an external audio signal in a case where the UE 800 is in an operational mode, such as a call mode, a recording mode, or a voice recognition mode. The received audio signal may be further stored in the memory 804 or transmitted via the communication component 816. In some embodiments, the audio component 810 further includes a speaker configured to output an audio signal.

The I/O interface 812 provides an interface between the processing component 802 and a peripheral interface module. The above-mentioned peripheral interface module may be a keyboard, a click wheel, a button, and the like. These buttons may include, but are not limited to, a home button, a volume button, a power button, and a lock button.

The sensor component 814 includes at least one sensor configured to provide state assessment in various aspects for the UE 800. For example, the sensor component 814 may detect the on/off state of the device 800 and relative location of components. For example, the components are a display and a keypad of the UE 800. The sensor component 814 may also detect positional changes of the UE 800 or one component of the UE 800, presence or absence of a contact between the user and the UE 800, an orientation or acceleration/deceleration of the UE 800, and temperature changes of the UE 800. The sensor component 814 may include a proximity sensor configured to detect presence of a nearby object without any physical contact. The sensor component 814 may further include an optical sensor, such as a CMOS or CCD image sensor, configured to be used in imaging applications. In some embodiments, the sensor component 814 may further include an acceleration sensor, a gyro sensor, a magnetic sensor, a pressure sensor, or a temperature sensor.

The communication component 816 is configured to facilitate wired or wireless communication between the UE 800 and other devices. The UE 800 may access a wireless network based on communication standards, such as WiFi, 2G, 3G, or a combination thereof. In one example, the communication component 816 receives a broadcast signal or broadcast-related information from an external broadcast management system via a broadcast channel. In one example, the communication component 816 further includes a near field communication (NFC) module to promote short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an example, the UE 800 may be implemented by at least one application specific integrated circuit (ASIC), digital signal processor (DSP), digital signal processing device (DSPD), programmable logic device (PLD), field programmable gate array (FPGA), controller, microcontroller, microprocessor, or other electronic components, and is configured to perform the methods described above.

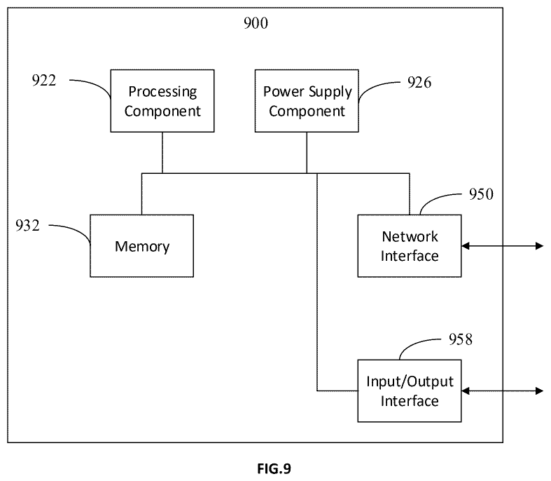

FIG. 9 is a block diagram of a network device 900 provided by an embodiment of the present disclosure. For example, the network device 900 may be provided as a network device. Referring to FIG. 9, the network device 900 includes a processing component 922 and a memory resource represented by a memory 932. The processing component 922 further includes at least one processor, and the memory resource is configured to store instructions executable by the processing component 922, such as an application program. The application program stored in the memory 932 may include one or more modules, each of which corresponds to a set of instructions. Additionally, the processing component 922 is configured to execute the instructions to perform any of the methods described above that are applied to the network device.

The network device 900 may further include a power supply component 926 configured to perform power supply management of the network device 900, a wired or wireless network interface 950 configured to connect the network device 900 to a network, and an input/output (I/O) interface 958. The network device 900 may be operated based on an operating system stored in the memory 932, such as Windows Server™, Mac OS X™, Unix™, Linux™, Free BSD™, or the like.

In the above embodiments provided by the present disclosure, the methods provided by the embodiments of the present disclosure have been introduced from the perspectives of the network device and the UE, respectively. In order to implement various functions in the methods provided by the embodiments of the present disclosure, the network device and the UE may include hardware structures and software modules, and the various above functions are implemented in a form of the hardware structures, the software modules, or the hardware structures and the software modules. A function of the various above functions may be performed in a manner of the hardware structures, the software modules, or the hardware structures and the software modules.

An embodiment of the present disclosure provides a communication device. The communication device may include a transceiver module and a processing module. The transceiver module may include a sending module and/or a receiving module. The sending module is configured to implement a sending function, the receiving module is configured to implement a receiving function, and the transceiver module may implement the sending function and/or the receiving function.

The communication device may be a terminal (such as the terminal in the above method embodiments), a device in the terminal, or a device that may be matched with the terminal for use. Alternatively, the communication device may be a network device, a device in the network device, or a device that may be matched with the network device for use.

An embodiment of the present disclosure provides another communication device. The communication device may be a network device, or a terminal (such as the terminal in the above method embodiments). The communication device may also be a chip, a chip system, or a processor, which supports the network device in implementing the above methods, or a chip, a chip system, or a processor, which supports the terminal in implementing the above methods. The device may be configured to implement the methods described in the above method embodiments. For details, reference may be made to the descriptions in the above method embodiments.

The communication device may include one or more processors. The processor may be a general-purpose processor or a dedicated processor. For example, the processor may be a baseband processor or a central processing unit. The baseband processor may be configured to process communication protocols and communication data, and the central processing unit may be configured to control the communication device (such as a network device, a baseband chip, a terminal, a terminal chip, a DU or a CU), execute a computer program, and process data of the computer program.

In some examples, the communication device may further include one or more memories in which a computer program may be stored. The processor executes the computer program to enable the communication device to perform the methods described in the above method embodiments. In some examples, data may also be stored in the memory. The communication device and the memory may be arranged separately or integrated together.

In some examples, the communication device may further include a transceiver and an antenna. The transceiver may be referred to as a transceiver unit, a transceiver machine, or a transceiver circuit, and is configured to implement a transmitting-receiving function. The transceiver may include a receiver and a transmitter. The receiver may be referred to as a receiving machine or a receiving circuit, and is configured to implement a receiving function. The transmitter may be referred to as a sending machine or a sending circuit, and is configured to implement a sending function.

In some examples, the communication device may further include one or more interface circuits. The interface circuit is configured to receive code instructions and transmit the code instructions to the processor. The processor runs the code instructions to enable the communication device to perform the methods described in the above method embodiments.

The communication device is a terminal, and the processor is configured to perform the methods shown in FIGS. 2 to 6.

In one implementation, the processor may include a transceiver configured to implement a receiving and sending function. For example, the transceiver may be a transceiver circuit, an interface, or an interface circuit. The transceiver circuit, interface, or interface circuit configured to implement the receiving and sending function may be separated or integrated together. The above transceiver circuit, interface, or interface circuit may be configured to read and write codes/data. Alternatively, the above transceiver circuit, interface, or interface circuit may be configured to transmit or transfer a signal.

In one implementation, the processor may store a computer program. The computer program is run on the processor to enable the communication device to perform the methods described in the above method embodiments. The computer program may be solidified in the processor, and in such a case, the processor may be implemented by hardware.

In one implementation, the communication device may include a circuit. The circuit may implement the sending, receiving, or communication function in the above method embodiments. The processor and the transceiver described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and the transceiver may also be manufactured using various IC process technologies, such as a complementary metal oxide semiconductor (CMOS), an nMetal-oxide-semiconductor (NMOS), a positive channel metal oxide semiconductor (PMOS), a bipolar junction transistor (BJT), a bipolar CMOS (BiCMOS), silicon germanium (SiGe), and gallium arsenide (GaAs).

The communication device described in the above embodiments may be a network device or a terminal (such as the terminal in the above method embodiments), but the scope of the communication device described in the present disclosure is not limited to this, and the structure of the communication device may not be limited. The communication device may be a standalone device or part of a larger device. For example, the communication device may be:
(1) an independent integrated circuit (IC), a chip, a chip system, or a subsystem;
(2) a set having one or more ICs, in some examples, the IC set may further include a storage component configured to store data and a computer program;
(3) an ASIC, such as a modem;
(4) a module capable of being embedded in other devices;
(5) a receiver, a terminal, an intelligent terminal, a cellular phone, a wireless device, a handset, a mobile unit, a vehicle-mounted device, a network device, a cloud device, an artificial intelligence device, etc.;
(6) others, etc.

In a case where the communication device may be a chip or a chip system, the chip includes a processor and an interface. There may be one or more processors, and a plurality of interfaces.

In some examples, the chip further includes a memory configured to store a necessary computer program and data.

Those skilled in the art may also understand that various illustrative logical blocks and steps listed in the embodiments of the present disclosure may be implemented by electronic hardware, computer software, or a combination thereof. Whether such a function is implemented by hardware or software depends on a specific application and the design requirements of the whole system. Those skilled in the art may use various methods to implement the described functions for each specific application, but such implementations are not to be understood as exceeding the scope of protection of the embodiments of the present disclosure.

The present disclosure further provides a readable storage medium having stored instructions thereon, and the instructions, when executed by a computer, implement the function of any of the above method embodiments.

The present disclosure further provides a computer program product, and the computer program product, when executed by a computer, implements the function of any of the above method embodiments.

All or part of the above embodiments may be implemented through software, hardware, firmware, or any combination thereof. All or part of the above embodiments may be implemented in a form of a computer program product when implemented by software. The computer program product includes one or more computer programs. All or part of the flows or functions according to the embodiments of the present disclosure are generated in a case where the computer program is loaded and executed on a computer. The computer may be a general-purpose computer, a dedicated computer, a computer network, or other programmable devices. The computer program may be stored in a computer-readable storage medium or transmitted from one computer-readable storage medium to another computer-readable storage medium. For example, the computer program may be transmitted from a website, computer, server, or data center to another website, computer, or data center in a wired (e.g., a coaxial cable, an optical fiber, or a digital subscriber line (DSL)) or wireless (e.g., infrared, radio or microwave) way. The computer-readable storage medium may be any available medium accessible by the computer, or a data storage device (such as a server or a data center) including one or more available media integrated. The available medium may be a magnetic medium (e.g., a floppy disk, a hard disk, or a magnetic tape), an optical medium (e.g., a high-density digital video disc (DVD)), or a semiconductor medium (e.g., a solid state disk (SSD)).

It is to be understood by those of ordinary skill in the art that various numerical numbers such as “first” and “second” involved in the present disclosure are merely intended to distinguish for convenient description, are not intended to limit the scope of the embodiments of the present disclosure, and also indicate an order.

“At least one” in the present disclosure may also be described as “one or a plurality of”, and “a plurality of” may be two, three, four, or more, which is not limited in the present disclosure. In the embodiments of the present disclosure, for a type of technical features, technical features in the type of technical features are distinguished by terms such as “first,” “second,” “third,” “A,” “B,” “C,” and “D,” and the technical features described by “first,” “second,” “third,” “A,” “B,” “C,” and “D” have no specific sequence or hierarchical order.

Those skilled in the art will easily think of other implementations of the present disclosure after considering the specification and practicing the invention disclosed herein. The present disclosure is intended to cover any variations, uses, or adaptations of the present disclosure that follow the general principle of the present disclosure and include the common knowledge or conventional technical means in the art, which are not disclosed by the present disclosure. The specification and the embodiments are to be regarded as exemplary merely, and the true scope and spirit of the present disclosure is defined by the following claims.

It is to be understood that the present disclosure is not limited to the precise structure described above and shown in the accompanying drawings, and various modifications and changes may be made without departing from its scope. The scope of the present disclosure is limited merely by the appended claims.

1. A method for transmitting a Physical Sidelink Feedback Channel (PSFCH), performed by a terminal, comprising:
determining N1 PSFCHs from N PSFCHs and at least one transmission beam, wherein the N PSFCHs are PSFCHs to be simultaneously transmitted by the terminal, both N and N1 are positive integers, N1 is less than or equal to N, N is greater than or equal to 2, and the at least one transmission beam is configured to transmit the N1 PSFCHs.

2. The method according to claim 1, wherein determining the at least one transmission beam comprises:
determining the at least one transmission beam as a default transmission beam.

3. The method according to claim 2, wherein the default transmission beam comprises at least one of:
an omnidirectional beam;
a transmission beam corresponding to a reception beam of a specific Sidelink-Synchronization Signal Block (S-SSB) resource; or
a transmission beam corresponding to a reception beam of a Sidelink Channel State Information-Reference Signal (SL CSI-RS) resource.

4. The method according to claim 2, wherein determining the N1 PSFCHs from the N PSFCHs comprises:
determining a maximum number M1 of PSFCHs supported to be simultaneously transmitted using the default transmission beam, wherein M1 is a positive integer and M1 is less than or equal to N; and
selecting the N1 PSFCHs from the N PSFCHs in a descending order of PSFCH transmission priorities, wherein N1 is less than or equal to M1.

5. (canceled)

6. The method according to claim 2, wherein determining the N1 PSFCHs from the N PSFCHs comprises:
determining a minimum power P1 used when transmitting one PSFCH using the default transmission beam; and
determining the N1 PSFCHs from the N PSFCHs according to the minimum power and a maximum transmission power Pmax of the terminal;
wherein a product of N1 and P1 is less than or equal to Pmax.

7. (canceled)

8. The method according to claim 1, wherein determining the at least one transmission beam comprises:
determining a number M2 of transmission beams supported to be simultaneously used by the terminal; and
determining the at least one transmission beam according to the number M2 of the transmission beams.

9. The method according to claim 8, wherein determining the number M2 of the transmission beams supported to be simultaneously used by the terminal comprises:
determining the number M2 of the transmission beams supported to be simultaneously used by the terminal according to at least one of:
a capability of the terminal;
pre-configuration information of the terminal;
received control information transmitted by a base station or a network device; or
implementation of the terminal.

10. The method according to claim 8, wherein determining the at least one transmission beam comprises at least one of:
determining the at least one transmission beam according to at least one of transmission beams of Physical Sidelink Control Channels (PSCCHs) corresponding to the N1 PSFCHs or reception beams of the PSCCHs; or
determining the at least one transmission beam according to at least one of transmission beams of Physical Sidelink Shared Channels (PSSCHs) corresponding to the N1 PSFCHs or reception beams of the PSSCHs;
wherein N1 is less than or equal to M2.

11. (canceled)

12. The method according to claim 8, further comprising at least one of:
determining N1 as a minimum value among N, M2, and M3, wherein M3 is configured to indicate a number of PSFCHs supported to be simultaneously transmitted by the terminal, and M2 is less than M3;
determining N1 as a minimum value among N, M2, and M4, wherein M4 is configured to indicate a maximum number of the PSFCHs supported to be simultaneously transmitted by the terminal, and a product of M4 and a minimum power P2 of the terminal for transmitting one PSFCH is less than or equal to the maximum transmission power Pmax of the terminal; or
determining, according to a minimum transmission power Pi corresponding to any PSFCH of the N PSFCHs and the maximum transmission power Pmax of the terminal, that a sum of minimum transmission powers corresponding to the N1 PSFCHs of the N PSFCHs does not exceed Pmax.

13. (canceled)

14. The method according to claim 8, further comprising:
selecting the N1 PSFCHs in a descending order of PSFCH transmission priorities.

15. The method according to claim 1, further comprising:
determining a first set, wherein the first set comprises at least one first transmission beam group, and transmission beams in the first transmission beam group are capable of being simultaneously used.

16. The method according to claim 15, wherein determining the N1 PSFCHs from the N PSFCHs comprises:
determining the N1 PSFCHs from the N PSFCHs according to the first set, wherein the N1 PSFCHs correspond to one first transmission beam group in the first set.

17. The method according to claim 16, wherein determining the N1 PSFCHs from the N PSFCHs according to the first set comprises:
determining a transmission beam corresponding to one PSFCH of the N PSFCHs; and
determining the N1 PSFCHs from the N PSFCHs, wherein transmission beams corresponding to the N1 PSFCHs belong to one first transmission beam group in the first set;
wherein determining the transmission beam corresponding to the one PSFCH of the N PSFCHs comprises at least one of:
determining the transmission beam corresponding to the one PSFCH according to at least one of a transmission beam of a Physical Sidelink Control Channel (PSCCH) corresponding to the one PSFCH or a reception beam of the PSCCH;
determining the transmission beam corresponding to the one PSFCH according to at least one of a transmission beam of a Physical Sidelink Shared Channel (PSSCH) corresponding to the one PSFCH or a reception beam of the PSSCH; or
determining the transmission beam corresponding to the one PSFCH according to a sending terminal of at least one of the PSCCH corresponding to the one PSFCH or the PSSCH corresponding to the one PSFCH.

18. (canceled)

19. The method according to claim 16, further comprising at least one of:
determining that N1 is not greater than M2, wherein M2 is configured to indicate a number of transmission beams supported to be simultaneously used by the terminal;
determining that N1 is not greater than M4, wherein M4 is configured to indicate a maximum number of PSFCHs supported to be simultaneously transmitted by the terminal, and a product of M4 and a minimum power P2 of the terminal for transmitting one PSFCH is less than or equal to the maximum transmission power Pmax of the terminal; or
determining, according to a minimum transmission power Pi corresponding to any PSFCH of the N PSFCHs and the maximum transmission power Pmax of the terminal, that a sum of minimum transmission powers corresponding to the N1 PSFCHs of the N PSFCHs does not exceed Pmax.

20. (canceled)

21. The method according to claim 1, further comprising:
determining a second set, wherein the second set comprises at least one second transmission beam group, and transmission beams in the second transmission beam group are not capable of being simultaneously used.

22. The method according to claim 21, wherein determining the N1 PSFCHs from the N PSFCHs comprises:
determining the N1 PSFCHs from the N PSFCHs according to the second set, wherein the N1 PSFCHs correspond to different second transmission beam groups in the second set.

23. The method according to claim 22, wherein determining the N1 PSFCHs from the N PSFCHs according to the second set comprises:
determining a transmission beam corresponding to one PSFCH of the N PSFCHs; and
determining the N1 PSFCHs from the N PSFCHs, wherein a transmission beam corresponding to a first PSFCH of the N1 PSFCHs and a transmission beam corresponding to a second PSFCH of the N1 PSFCHs belong to different second transmission beam groups in the second set;
wherein determining the transmission beam corresponding to the one PSFCH of the N PSFCHs comprises at least one of:
determining the transmission beam corresponding to the one PSFCH according to at least one of a transmission beam of a Physical Sidelink Control Channel (PSCCH) corresponding to the one PSFCH or a reception beam of the PSCCH;
determining the transmission beam corresponding to the one PSFCH according to at least one of a transmission beam of a Physical Sidelink Shared Channel (PSSCH) corresponding to the one PSFCH or a reception beam of the PSSCH; or
determining the transmission beam corresponding to the one PSFCH according to a sending terminal of at least one of the PSCCH corresponding to the one PSFCH or the PSSCH corresponding to the one PSFCH.

24. (canceled)

25. The method according to claim 21, further comprising at least one of:
determining that N1 is not greater than M2, wherein M2 is configured to indicate a number of transmission beams supported to be simultaneously used by the terminal;
determining that N1 is not greater than M4, wherein M4 is configured to indicate a maximum number of PSFCHs supported to be simultaneously transmitted by the terminal, and a product of M4 and a minimum power P2 of the terminal for transmitting one PSFCH is less than or equal to the maximum transmission power Pmax of the terminal; or
determining, according to a minimum transmission power Pi corresponding to any PSFCH of the N PSFCHs and the maximum transmission power Pmax of the terminal, that a sum of minimum transmission powers corresponding to the N1 PSFCHs of the N PSFCHs does not exceed Pmax.

26. (canceled)

27. (canceled)

28. A terminal, comprising a processor and a memory, wherein the memory stores a computer program, and the processor executes the computer program stored in the memory to enable the terminal to perform:
determining N1 PSFCHs from N PSFCHs and at least one transmission beam, wherein the N PSFCHs are PSFCHs to be simultaneously transmitted by the terminal, both N and N1 are positive integers, N1 is less than or equal to N, N is greater than or equal to 2, and the at least one transmission beam is configured to transmit the N1 PSFCHs.

29. (canceled)

30. A non-transitory computer-readable storage medium, configured to store instructions, wherein the instructions, when executed, cause the following step to be implemented:
determining N1 PSFCHs from N PSFCHs and at least one transmission beam, wherein the N PSFCHs are PSFCHs to be simultaneously transmitted by the terminal, both N and N1 are positive integers, N1 is less than or equal to N, N is greater than or equal to 2, and the at least one transmission beam is configured to transmit the N1 PSFCHs.
